(19) United States
(12) Patent Application Publication
(10) Pub. No.: US 2008/0091515 A1
(43) Pub. Date: Apr. 17, 2008

(54) METHODS FOR UTILIZING USER EMOTIONAL STATE IN A BUSINESS PROCESS

(75) Inventors: Gil Thieberger, Kiryat Tivon (IL); Michal Rosenfeld, Haifa (IL); Michael Karasik, Jersealem (IL); Keren Rotberg, Kiryat Tivon (IL)

Correspondence Address: PatentVC Ltd., POB 294, Kiryat Tivon, 36010, IL

(73) Assignee: PatentVC Ltd., Kiryat Tivon (IL)

(21) Appl. No.: 11/873,240

(22) Filed: Oct. 16, 2007

Related U.S. Application Data
(60) Provisional application No. 60/851,998, filed on Oct. 17, 2006.

(51) Int. Cl. G06F 17/30

(52) U.S. Cl. 705/10

(57) ABSTRACT

Methods for receiving emotional state indications and identifying a business process problematic part or providing statistical data in correlation with corresponding business process parts or comparing interchangeable business process parts.

### CROSS-REFERENCE TO RELATED APPLICATIONS

This application claims the benefit of U.S. Provisional Patent Application No. 60/851,998, filed Oct. 17, 2006.

### BACKGROUND

Users may have personal differences in the way they express emotions. For example, one user may be more introverted and another more extraverted. These personal differences may be taken into account when analyzing the emotional states of users. For example, a system may use a learning algorithm to learn how a specific user typically exhibits specific emotions, and may build a user profile regarding the way emotional states are exhibited by the user. A system may associate a different scale of emotional intensity with different users. Such a system may, for example, consider one user very happy when slightly smiling and another user very happy only when loud laughter is detected.

When an attempt is made to detect an emotional state of a system user, cultural differences may play a significant role. For example, recognizing even slight cues of an emotion in a user with a specific cultural background may actually mean very strong emotions; and vice versa, in some cultures exhibition of strong emotions does not necessarily mean that the person is actually feeling them strongly. A cultural background of a user may, for example, be obtained from a database, or detected using visual or auditory devices. This cultural background may be used to improve the accuracy of emotion detection methods.

Methods for detecting an emotional state of a user are widely known in the art. An emotional state may be detected by using any of the following means: input from audio or video devices, analysis of a user's interaction with devices such as a mouse or keyboard, analysis of a user's posture, analysis of digital data relevant to a user such as the user's correspondence, preferences and history, input from sensors capable of sensing parameters regarding a user, and any other means capable of assisting in detecting an emotional state.

An emotional state may be detected by using parameters regarding the user such as biometric data (heart rate, skin temperature, blood pressure, perspiration, weight, or any other measurable user conditions). Numerous methods are available for measuring such parameters. For example, heart rate and perspiration levels may be determined by conductance of hands on a device (e.g. a pointing device); Head position, eye position and facial expressions may be measured via a camera located near the user (e.g. a web-cam attached to a monitor, or a surveillance camera); seat motion sensors may measure changes in a person's position in the seat; Sound sensors may be used to measure sounds indicative of movement, emotion, etc. Each of these sensors measures various elements that may be used to determine emotional information regarding the user.

For example, persistent movement of the user in the seat, an increased heart rate, or increased perspiration may each be an indication that the user's anxiety level is rising. Simultaneous occurrence of more than one of these indications may indicate a severe level of anxiety. Sound sensors may detect sounds indicating fidgeting movement. In addition, sound sensors may sense angry voices, loud music, or crying, all of which may be indicators of a condition the user is in. Head position and eye position may also indicate whether or not the user is paying attention to a monitor.

A variety of sensors may provide information about the current physiological state of the user and current user activities. Some devices, such as a microphone, may provide multiple types of information. For example, a microphone may provide sensed information related to the user (e.g., detecting that the user is talking, snoring, singing or typing) when not actively being used for user input. Other user-worn body sensors may provide various types of information, such as information from a thermometer, sphygmomanometer, heart rate sensor, shiver response sensor, skin conductivity sensor, eyelid blink sensor, pupil dilation detection sensor, EEG and EKG sensors, sensor to detect brow furrowing, blood sugar monitors, etc. In addition, sensors elsewhere in the near environment may provide information about the user, such as motion detector sensors (e.g., whether the user is present and is moving), badge readers, video cameras (including low light, infra-red, and x-ray), remote microphones, etc. These sensors may be either passive (i.e., detecting information generated external to the sensor, such as a heart beat) or active (i.e., generating a signal to obtain information, such as sonar or x-rays).

Stored background information about the user may be supplied to assist in detecting the emotional state. Such information may include demographic information (e.g., race, gender, age, religion, birthday, etc.), and user preferences, either explicitly supplied or learned by the system. Information about the user's physical or mental condition that affects the type of information the user can perceive and remember, such as blindness, deafness, paralysis, or mental incapacitation, may also serve as background information.

In addition to information related directly to the user, information related to the environment surrounding the user may also be used. For example, devices such as microphones or motion sensors may be able to detect whether there are other people near the user and whether the user is interacting with those people. Sensors may also detect environmental conditions which may affect the user, such as air thermometers, and chemical sensors.

In addition to receiving information directly from low-level sensors, information may also be received from modules which aggregate low-level information or attributes into higher-level attributes (e.g., face recognition modules, gesture recognition modules, emotion recognition modules, etc.).

### BRIEF DESCRIPTION OF THE DRAWINGS

FIG. 1 is a flowchart illustrating the process steps of identifying a correlation between an event and emotional states of users according to one embodiment.

FIG. 2 is a flowchart illustrating the process steps of performing an automatic action based on an identified correlation according to one embodiment.

FIG. 3 is a flowchart illustrating the process steps of providing data based on an identified correlation according to one embodiment.

FIG. 4 is a schematic illustration of a screen display showing an informative window according to one embodiment.

FIG. 5 is a schematic illustration of a screen display showing a dashboard indicator according to one embodiment.

FIG. 6 is a flowchart illustrating the process steps of comparing an identified correlation to another correlation according to one embodiment.

FIG. 7 is a flowchart illustrating the process steps of generating statistical data according to one embodiment.

FIG. 8 is a flowchart illustrating the process steps of identifying a problematic part of a business process according to one embodiment.

FIG. 9 is a flowchart illustrating the process steps of providing statistical data according to one embodiment.

FIG. 10 is a flowchart illustrating the process steps of generating statistical data according to one embodiment.

FIG. 11 is a schematic illustration of a screen display showing an informative window according to one embodiment.

FIG. 12 is a schematic illustration of a screen display showing an informative window according to one embodiment.

FIG. 13 is a schematic illustration of a screen display showing an informative window according to one embodiment.

FIG. 14 is a schematic illustration of a screen display showing an informative window according to one embodiment.

FIG. 15 is a schematic illustration of a screen display showing an informative window in accordance with an embodiment of the present invention.

FIG. 16 is a flowchart illustrating the process steps of associating an abstract business process with an emotional status according to one embodiment.

FIG. 17 is a flowchart illustrating the process steps of providing an abstract business process correlated with an emotional status according to one embodiment.

FIG. 18 is a flowchart illustrating the process steps of providing an emotional status in a defined level of abstraction according to one embodiment.

FIG. 19 is a flowchart illustrating the process steps of associating an emotional status with a virtual task according to one embodiment.

FIG. 20 is a flowchart illustrating the process steps of determining a manner in which to display a document element according to one embodiment.

FIG. 21 is a flowchart illustrating the process steps of determining a manner in which to provide a document element according to one embodiment.

FIG. 22 is a flowchart illustrating the process steps of determining a manner in which to provide a document element according to one embodiment.

FIG. 23 is a flowchart illustrating the process steps of determining a manner in which to provide auditory content according to one embodiment.

FIG. 24 is a flowchart illustrating the process steps of modifying a manner in which a document element is provided according to one embodiment.

FIG. 25 is a flowchart illustrating the process steps of determining a manner in which to provide a document action according to one embodiment.

FIG. 26 is a flowchart illustrating the process steps of determining whether to allow a user to perform an action according to one embodiment.

FIG. 27 is a flowchart illustrating the process steps of providing a user with an adapted business process part according to one embodiment.

FIGS. 28a-28d are schematic illustrations of document structure and display according to one embodiment.

FIG. 29 is a schematic illustration of a screen display showing an electronic form according to one embodiment.

FIG. 30 is a flowchart illustrating the process steps of modifying an environment of at least one user according to one embodiment.

FIG. 31 is a flowchart illustrating the process steps of performing an environment modification according to one embodiment.

FIG. 32 is a flowchart illustrating the process steps of determining a manner in which to operate an emotion induction process according to one embodiment.

FIG. 33 is a flowchart illustrating the process steps of determining whether to modify an environment according to one embodiment.

FIG. 34 is a flowchart illustrating the process steps of inducing a desired emotional state according to one embodiment.

FIG. 35 is a flowchart illustrating the process steps of inducing a desired emotional state according to one embodiment.

FIG. 36 is a flowchart illustrating the process steps of inducing a desired emotional state according to one embodiment.

FIG. 37 is a flowchart illustrating the process steps of inducing a desired emotional state according to one embodiment.

FIG. 38 is a schematic illustration of a business process based emotion inducing system according to one embodiment.

FIG. 39 is a flowchart illustrating the process steps of adjusting user input based on an emotional state of the user according to one embodiment.

FIG. 40 is a flowchart illustrating the process steps of determining an effect of an emotional state of a user on input of the user to an entry field according to one embodiment.

FIG. 41 is a flowchart illustrating the process steps of adjusting user input to an entry field according to one embodiment.

FIG. 42 is a flowchart illustrating the process steps of adjusting user input to an entry field according to one embodiment.

FIG. 43 is a flowchart illustrating the process steps of determining an effect of an emotional state of a user on input of the user to an entry field according to one embodiment.

FIG. 44 is a flowchart illustrating the process steps of adjusting user input to an entry field according to one embodiment.

FIG. 45 is a flowchart illustrating the process steps of determining an effect of emotional states of users on input of the users to an entry field according to one embodiment.

FIG. 46 is a flowchart illustrating the process steps of adjusting user input to an entry field according to one embodiment.

FIG. 47 is a flowchart illustrating the process steps of analyzing the relationships between business process related inputs and emotional states of users according to one embodiment.

FIG. 48 is a flowchart illustrating the process steps of adjusting business process related inputs to a predefined standard according to one embodiment.

FIG. 49 is a flowchart illustrating the process steps of adjusting business process related inputs to a predefined standard according to one embodiment.

FIG. 50 is a flowchart illustrating the process steps of adjusting user input to a predefined standard based on an emotional state of the user according to one embodiment.

FIG. 51 is a schematic illustration of a measurements and averages table according to one embodiment.

FIG. 52 is a schematic illustration of a screen display showing an informative window according to one embodiment.

### DETAILED DESCRIPTION

In the following description, numerous specific details are set forth. However, it is to be understood that the embodiments of the invention may be practiced without these specific details. In other instances, well-known hardware, software, materials, structures and techniques have not been shown in detail in order not to obscure the understanding of this description. In this description, references to “one embodiment” or “an embodiment” mean that the feature being referred to is included in at least one embodiment of the invention. Moreover, separate references to “one embodiment” in this description do not necessarily refer to the same embodiment; however, neither are such embodiments mutually exclusive, unless so stated and except as will be readily apparent to those of ordinary skill in the art. Thus, the invention may include any variety of combinations and/or integrations of the embodiments described herein. Also herein, flow diagrams illustrate non-limiting embodiment examples of the methods; block diagrams illustrate non-limiting embodiment examples of the devices. Some of the operations of the flow diagrams are described with reference to the embodiments illustrated by the block diagrams. However, it is to be understood that the methods of the flow diagrams could be performed by embodiments of the invention other than those discussed with reference to the block diagrams, and embodiments discussed with references to the block diagrams could perform operations different than those discussed with reference to the flow diagrams. Moreover, it is to be understood that although the flow diagrams may depict serial operations, certain embodiments could perform certain operations in parallel and/or in different orders than those depicted.

The term “user” refers to any entity capable of exhibiting detectable emotions, such as a human being.

Without limiting the scope of the invention, the term “emotional state” as used herein refers to any combination of the following: emotions, such as sadness, happiness, angriness, agitation, depression, frustration, fear, etc; mental states and processes, such as stress, calmness, passivity, activeness, thought activity, concentration, distraction, boredom, interestedness, motivation, morale, awareness, perception, reasoning, judgment, etc; physical states, such as fatigue, alertness, soberness, intoxication, etc; and socio-emotional states, which involve other people and are typically related to secondary emotions such as guilt, embarrassment, or jealousy. In one embodiment, an emotional state may have no explicit name and instead comprise a set of values or biometric data parameters relevant to emotions, such as voice pitch, heart rate, skin temperature, etc.

The term “entry field” as used herein may refer to a text-box, a widget (e.g. a radio button or a check-box), a drop-down menu, a button, an entire electronic form, a combination thereof, or any other data receptacle capable of receiving input. The input may be received by using a mouse, a keyboard, a voice recognition device, a communication link, a combination thereof, or any other device capable of generating input for the entry field.

It is to be understood that an emotional state detection algorithm may be implemented by a variety of methods and sensors. Moreover, the performance and characteristic of an emotional state detection algorithm may be adjusted to a specific need of a specific embodiment. For example, there may be an embodiment wherein it is preferable to operate the emotional state detection according to external indications of the user, i.e., activities the user exhibits. Alternatively, it may be preferred to operate the emotional state detection algorithm according to the emotional state the user is undergoing, i.e. the emotional state the user is experiencing.

The term “business process” as used herein may also refer to a workflow, an e-learning process, and/or to a software wizard process.

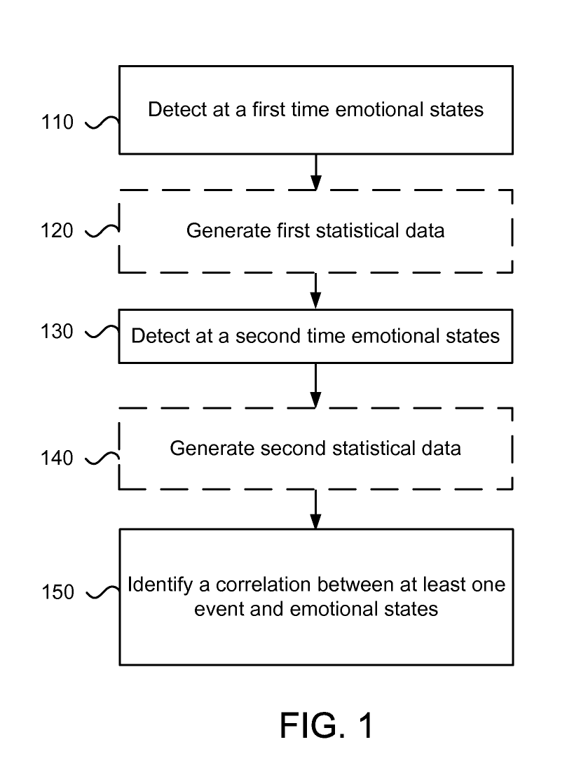

One aspect of the embodiments of the methods for identifying correlations between events and emotional states of users is described herein. FIG. 1 illustrates one embodiment. In step 110 emotional states of users in a group are detected for a first time. Emotional states may be detected by using a device capable of detecting parameters relevant to a user's emotions. The group of users may employees of an organization, wherein the organization may be an enterprise, governmental organization, an educational facility, a private company or any other type of organization.

In steps 120 and 140 first and second optional intermediate statistical data are generated based on the detected emotional states. The statistical data may comprise, for example, an average emotional state of users in the group, a standard deviation of an emotion in the group, extremes in the distribution of emotional states among the users or any other data based on statistical operations. Furthermore, statistics may pertain to a single emotion of users, such as morale of employees, or it may pertain to more than one emotion and may comprise multiple values. Moreover, the statistical data of steps 120 and 140 may be generated for different subgroups.

The group may include, but is not limited to, any of the following groups: a department, a workgroup, users of a specific sex, users with a specific job, users answering a specific criterion such as relatedness to a project or a business process, or any other group in an organization. A group may comprise all users of the organization.

The group may consist of subgroups. For example, if the group is the sales department, possible subgroups may be users who are in the sales department for more than two years, users having personal issues, users who excelled in their work this month, etc.

It may be difficult to detect emotional states of all users in a group. Thereby, emotional states may be detected for only a subset of the group, and this subset may represent the entire group. For example, instead of sampling an entire department, it is possible to randomly pick only a certain percent of the people in the department, and the emotional states detected for that percent of people represent the emotional state of the entire department. Alternatively or additionally, people may be chosen to represent a group because they have certain characteristics. For another example, the ratio of men to women in a subset of people chosen to represent a department may be the same as the ration of men to women in the department. It may be possible to detect emotional states of a group of users even when some users who are members of the group are missing. For example, the emotional state of a certain department on a certain day may be represented by the emotional states of people belonging to the department that are present on that day, and may be detected even when some members of the department are absent from work on that particular day.

In step 130 emotional states of users in the group are detected for a second time. In an embodiment, an event may have occurred between the first and second times the emotional states were detected. In another embodiment, the event may be a continuous event that begins before the first time and ends after the second time. It is also possible that both the first and second times are either before the event began or after it ended. Any chronological combination of an event and the first and second times in which emotional states are detected is possible.

The aforementioned event may be any of the following events: a new policy in the organization, a change in an existing policy, a change in the organization's structure, a change in management, a publication relevant to the organization, a new initiative by the organization's management, an event indirectly relevant to the organization such as an important political event and any other event that may potentially have an effect on emotional states of users in the organization.

In step 150 a correlation is identified between an event and emotional states of the users in the group based on a comparison between the first and second statistical data. The correlation may be identified by identifying a difference between the first and second statistical data. For example, in one embodiment, an organization may need to measure a change in employee morale following an event such as a change in the organization's management. Announcement of the event may be scheduled to a predefined time and employee morale may be detected prior to the announcement (first statistical data) and immediately after the announcement (second statistical data). If the second statistical data shows better overall employee morale than the first statistical data, this difference may be correlated with the event. Optionally, the difference may be at least partially caused by some other event. In this case, the other event may be taken into account when identifying the correlation. For example, if the aforementioned improvement in morale was detected on a sunny day that followed a stormy week, then when identifying the above correlation a possible emotional reaction to the change in weather may be taken into account. Optionally, the identified correlation may be an assumed correlation, i.e. one that is not certain. In such a case, the correlation may have a certainty score attached to it.

In another embodiment of the invention, emotional states of users may be continuously monitored and some technique, e.g. data mining, may be used to compare emotional states of users at different times and determine certain anomalies. An anomaly may be, for example, a sudden change in an emotion exhibited by users. Once an anomaly is detected an attempt may be made to identify a correlation between the anomaly in the emotional states of users and an event which might have caused the anomaly. This correlation may be, for example, identified by accessing a database that contains data about a set of events, and identifying a chronological correlation between an event and the anomaly. In another example, a user responsible for identifying the correlation may be presented with data pertaining to the anomaly and with a list of events chronologically proximate to the anomaly and be prompted to choose the event or events which presumably caused the anomaly.

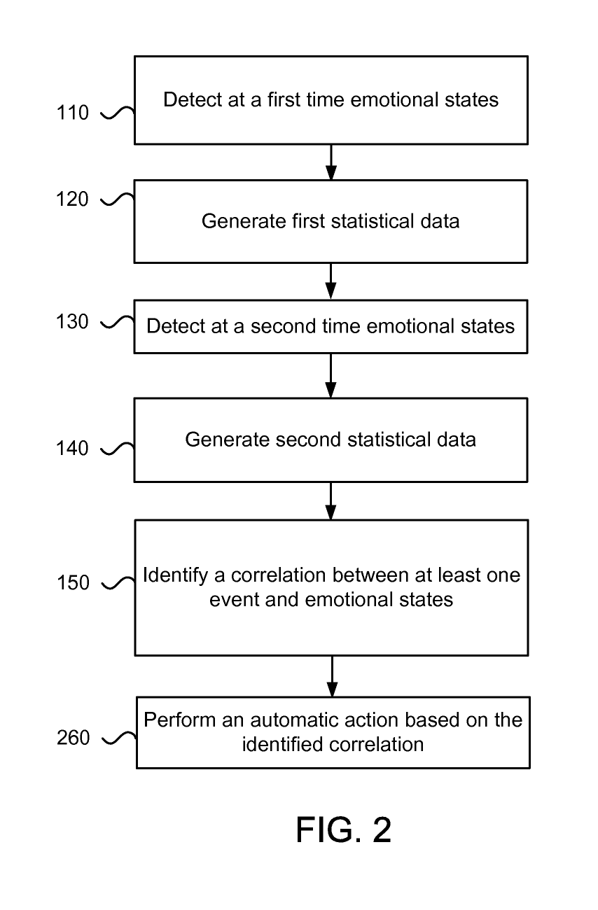

In one embodiment illustrated by step 260 in FIG. 2, an automatic action is performed based on the identified correlation. The automatic action may include, but is not limited to, any of the following actions: changing a policy of the organization, restoring a previous policy, an action aimed at changing the emotional states of the users such as broadcasting a message with appropriate content, an action aimed at intensifying results of the event such as repeating the event, and an action aimed at diminishing results of the event such as initiating a counter-active event. In an embodiment, the automatic action may be performed only if the identified correlation meets a certain criterion, for example, only if the correlation suggests a significant rise in employee anger. Furthermore, the automatic action may be performed in a specific manner based on the correlation, for example, a more significant rise in employee anger may cause the automatic action to be performed with greater intensity. The automatic action may be generation of a notification, for example, to notify a responsible supervisor. The notification may include details of the identified correlation. For example, a notification may be: ‘The algorithm has determined with a 76% certainty that the recent publication in the Times is responsible for the 3.4% increase in employee depressive emotions’.

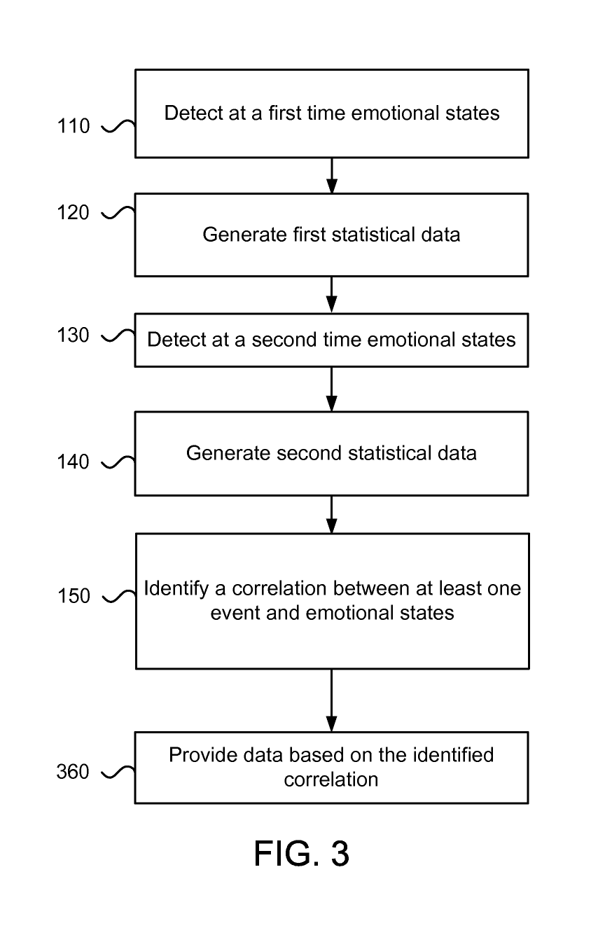

In one embodiment illustrated by step 360 in FIG. 3, data is provided based on the identified correlation. The provided data may be in the form of an indicator in a dashboard. The provided data may contain information relevant to the event itself, to the generated statistical data, to the identified correlation, or any other appropriate data. The provided data may be a score of the event, which is based on the identified correlation. For example, a score may indicate whether the event had a positive or negative effect, or may indicate the intensity of the effect. In one embodiment, the provided data may be a chart indicating emotional states of users. For example, the chart may be a chronological chart, a graph, a pie chart, a table or a flow chart. The event may be indicated on the chart to illustrate the identified correlation. The provided data may be further based on a source other than the identified correlation. For example, if the provided data is a score of the event, the score may be based on a change in the emotional states of users and also on some other consequences of the event, such as financial or political consequences.

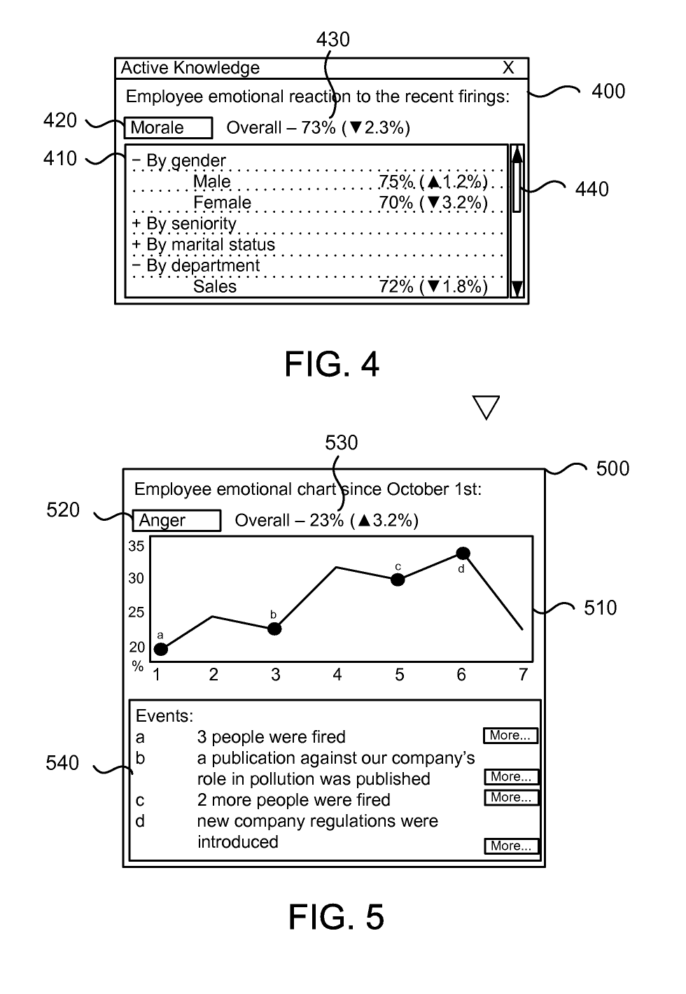

FIG. 4 is a schematic illustration of a screen display showing an informative window 400 in accordance with one embodiment. The informative window provides information about the emotional reaction of employees to an event of recent firings. A drop down menu 420 allows a user of the informative window to choose an emotion for which to receive information. The chosen emotion illustrated is morale. An indicator 430 shows an overall evaluation of the chosen emotion among employees, which is 73%, and the change presumably caused by the recent event (−2.3%). Another portion 410 of the window allows viewing these statistics for various groups of the organization. A scrollbar 440 is present for scrolling this window.

FIG. 5 is a schematic illustration of a screen display showing a dashboard indicator 500 in accordance with one embodiment. The indicator provides information about changes in emotional states of employees since October 1st. A drop down menu 520 allows a user to choose an emotion for which to receive information. An indicator 530 shows an overall evaluation of the chosen emotion, and the changes since the specified date. A chronological chart 510 illustrates these changes in more detail. The four marks on the chart (a-d) represent events which occurred at their respective points in time. A legend 540 elaborates on the meaning of the marks.

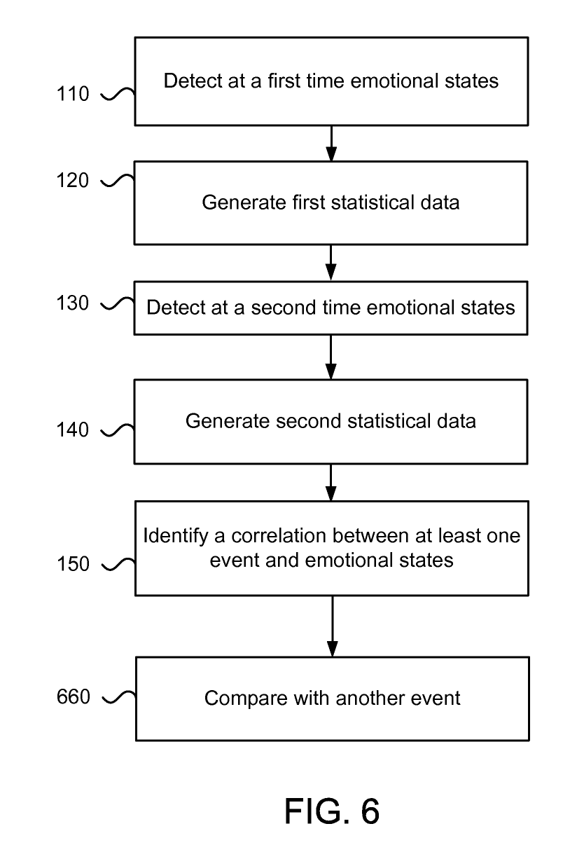

In one embodiment illustrated by step 660 in FIG. 6, the identified correlation is compared with data relevant to another event and based on this comparison, actions may be performed. Such actions include, but are not limited to, determining the relative strength of the identified correlation or determining its level of certainty. For example, if a past event similar to the current event had emotionally affected users for a specific period of time, it may be presumed that the current event will affect users for a similar period of time. In another example, an intensity of a current event's effect on emotional states may be compared to an average level of intensity produced by a set of previous similar events. The comparison may be used to determine whether the current event's intensity is more or less than average. Optionally, two or more events may be compared to each other using the above comparison and various conclusions may be drawn accordingly. In an embodiment, correlation of an event with emotional states may be compared to similar events in the past to determine existence of trends in users' emotional responses to the events. For example, in an organization wherein employees regularly receive bonuses, an emotional response to the received bonuses may be monitored, and by comparing each subsequent response, it may, for example, be determined that employees' positive reactions to these bonuses gradually decreases. Optionally, the identified correlation may be compared with a correlation identified for another event; the other correlation may be identified according to one embodiment.

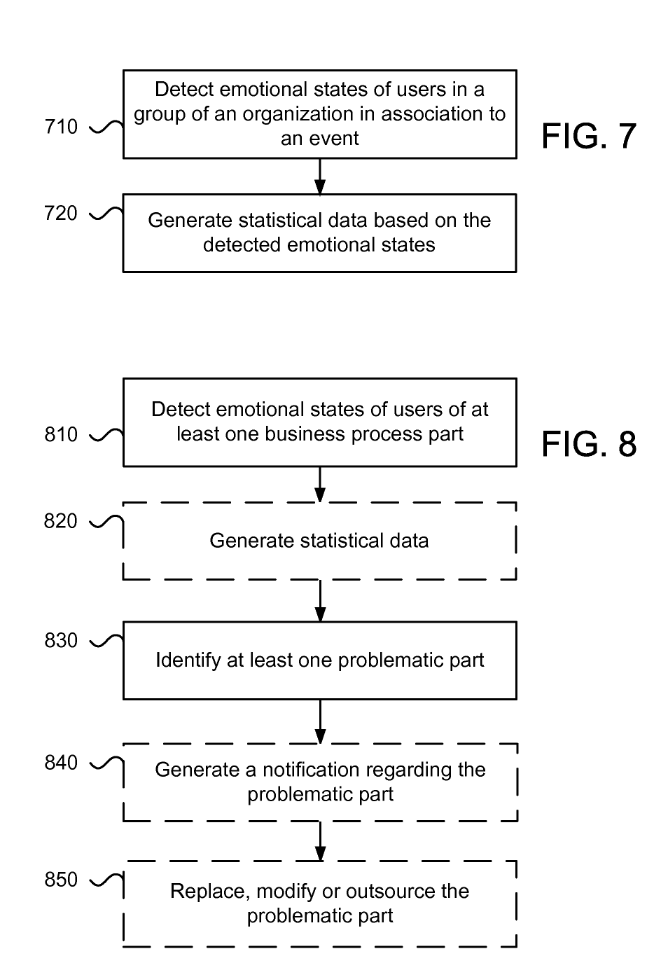

Referring to FIG. 7, in step 710 emotional states of users in a group of an organization are detected. The detected emotional states are associated with an event. The association between the emotional state of a user and an event may be derived, for example, from the context of the detected emotional state. This context may be any of the following: user's speech, user's correspondence, user's behavior, background voices, user's interactions with a device user's interactions with a software, or any other contextual data relevant to the detected emotional state. For example, if a user writes or receives a message regarding an event and is very angry at the same time, the user's emotional state may be detected and the content of the message may be used to associate the detected emotional state with the aforementioned event. Different contextual data may be used for different users in the group. In step 720 statistical data is generated based on the detected emotional states. The generated statistical data may be stored and later used in a process such as a data mining process.

Another aspect of the embodiments of the methods for analyzing business process by emotional state detection is described herein. FIG. 8 illustrates one embodiment of the invention. In step 810 emotional states of users of at least one part of at least one business process are detected. In one embodiment, emotional states may be detected for any two parts of the at least one business process (i.e. at least two parts of the same business process or at least one part from at least two business processes). A part of a business process may be, for example, a business process step, an entry field in a business process, a widget such as a drop down menu, an activity related to a business process, a document related to a business process, an entire business process or any number or combination thereof. A business process may be broken into parts in more than one way and using more than one strategy. For example, in a business process comprised of business process steps which represent the different sequential screens of the business process the process steps may be considered as parts of the business process. As another example, every field of a business process may be considered as a distinct part.

In one embodiment, an eye-tracking device may be used to help identify fields in a business process step gazed upon by a user, and an emotion-recognition device may be used to recognize the user's emotional state corresponding to the identified fields of the business process.

In another embodiment of the invention, if a user exhibits an emotional state such as irritation and confusion at a certain point in time, the business process part corresponding to this emotional state may be derived by considering the flow of the business process until this point, activities of the user which may provide a clue as to which business part the user is preoccupied with, processes running in the system which may correspond to some business process part, etc.

In optional step 820 statistical data is generated based on the detected emotional states. In one embodiment, the generated statistical data may pertain to a single part of a business process or to multiple, not necessarily sequential, parts. For example, the statistical data may comprise average values for emotions detected for a group of users. Furthermore, the statistical data may be generated while taking into account contextual data other than emotional states of users. For example, if the statistical data comprises a score given to a part of a business process, this score may be a function of multiple variables such as average levels of emotions exhibited by users of this part, an average financial cost of this part, an average duration of the part, percentage of failure, etc.

In one embodiment, contextual data taken into account when generating statistical data may comprise data relating to events outside the business process that affect emotional states of users.

Furthermore, in one embodiment, personal and cultural differences of users may be taken into account when generating the statistical data. For example, recognizing even slight cues of an emotion in a user with a specific personality or cultural background may actually mean very strong emotions; and vice versa, a user having another personality or cultural background may exhibit strong emotions, such as agitation, while not necessarily feeling them strongly. A personal or cultural profile of a user may, for example, be obtained from a database, or be detected using visual, auditory or other devices.

In one embodiment, statistical data may be generated for a group of users and may comprise data about multiple instances of the at least one business process. A user of the group may participate in one, more than one, or none of the multiple instances.

In step 830 at least one problematic part of the at least one business process is identified based on the generated statistical data. This step may be a manual step performed by a human, a semi-automatic step performed by both human and a machine, or an automatic process performed entirely by a machine.

In one embodiment, a part of the business process may be identified as problematic if the generated statistical data meets a certain criterion. For example, if the statistical data comprises scores for different parts of a business process, a part may be identified as problematic if its corresponding score is lower than a predefined threshold. In another example, a part of a business process may be considered problematic if an average level of some emotion or combination of emotions among users performing the part is beyond a threshold. For instance, some part may be considered problematic if users exhibit confusion and anger during this part, and it takes, in average, a longer time than expected to complete.

Optionally, in step 840, a notification is generated regarding the at least one problematic part. The notification may, for example, be addressed to a supervisor such as an IT manager or a business analyst. The notification may be, for example, in the form of an e-mail, an SMS, a system alert, an instant message, etc.

Optionally, in step 850, replacement, modification or outsourcing of the at least one identified problematic part is performed. This step may be performed automatically, semi-automatically or manually. In one embodiment, two or more interchangeable parts exist for a business process, and if a specific emotion of a group of users in one such part reaches a certain threshold, the part is automatically replaced by one of the alternatives. This embodiment may be used, for example, to keep employees from becoming irritated by a certain part in a business process by switching to a different version right after the part is first identified as annoying. Thus, high employee morale and motivation are encouraged. In one embodiment, a part of a business process may be optional. This part may be automatically removed or minimized if an extremely negative emotion associated with this part is detected in users. In one embodiment, if detected emotional states of users indicate that they are struggling with a part of a business process, the problematic part may be complemented with additional components such as an option of live support or hints automatically taken from a help file relevant to the business process. In one embodiment, a problematic part that is essential and cannot be removed from the business process may, for example, be outsourced, optionally to a predefined party. The outsourcing may, for example, be performed by an automatic process or manually by a person in charge.

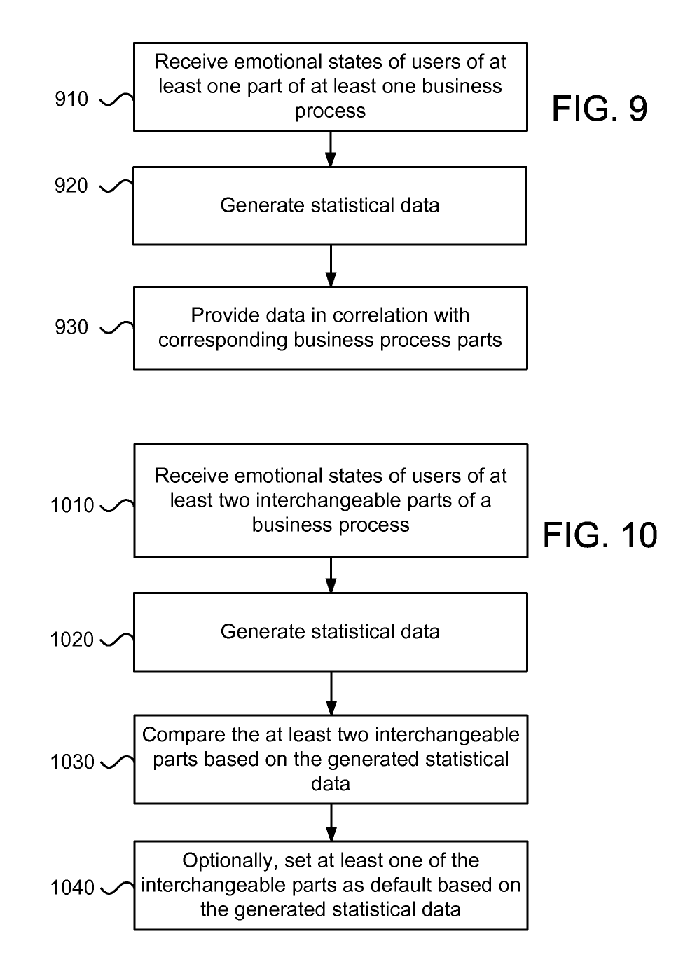

Referring to FIG. 9, in step 910 emotional states of users of at least one part of at least one business process are received. The emotional states may be obtained and/or detected using any appropriate method. In step 920 statistical data is generated based on the detected emotional states. When generating statistical data, additional contextual data relevant to the business process parts may be taken into account. The generated statistical data may describe a single emotion, such as morale or anger, multiple emotions, or a function of two or more emotional state parameters, such as, but not limited to, a formula including happiness, calmness and alertness. In one embodiment, the statistical data comprises an estimation of an overall morale of users in at least one business process part. The overall moral of the users may be a function of detected emotional states of users, how many working hours the users are working, the day of the week, the month, and other environmental and contextual parameters. In step 930 data based on the generated statistical data is provided in correlation with corresponding business process parts. In one embodiment, emotional states are detected for users of two similar parts of two business processes and the provided data comprises a comparison between the emotional states of users of the parts. In one embodiment, the provided data comprises a comparison between at least two interchangeable parts of the at least one business process, such as illustrated in FIG. 13.

The provided data may comprise an indication of a problematic part of the at least one business process. For example, the generated statistics may comprise average levels of emotions in various business process parts, these statistics may be used to identify problematic parts, and the problematic parts may be provided in a list, or, alternatively, a list of all parts may be provided wherein the problematic ones are indicated.

The provided data may be provided by a business activity monitoring (BAM) software, which is known in the art. Such BAM software may optionally receive generated statistical data describing the emotional state of the users from a component that detects and analyzes the emotional states of monitored users.

In one embodiment, a user may be provided with statistical data pertaining to emotional states of a specific group of users in a part of a business process. The group may include a subgroup of the group of all users of the business process part. For example, the group of all users may be the sales department, and possible subgroups may be users who are in the sales department for more than two years, users having personal issues, users who excelled in their work this month, etc.

Referring to FIG. 10, in step 1010 emotional states of users in at least two interchangeable parts of a business process are received. Examples of interchangeable parts are different views of the same business process part, or different possible business process parts that serve a similar purpose in the business process from which a user may be able to choose. It may be possible to perform an action in a business process in more than one way (e.g. find files manually, or let the system try to locate them automatically), and the different ways of performing an action may be considered as interchangeable parts of the corresponding business process. As another example, if some part of a business process may be completed by performing a sequence of actions in more than one order, instances of the same part wherein the actions are ordered in different ways may be considered as interchangeable parts. In step 1020 statistical data is generated based on the detected emotional states. In step 1030 the at least two interchangeable parts are compared based on the generated statistical data. For example, the generated statistical data may comprise data about an average amount of users who get extremely angry in each of the interchangeable parts, and these parts may be compared by comparing the aforementioned average amounts. The comparison may be used, for example, to sort the interchangeable parts according to a criterion or to choose a part that has an extreme value. A result of the comparison may optionally be provided to a user. For instance, interchangeable parts may be sorted according to a criterion of overall morale of users of the interchangeable parts, and a user may be provided with the resulting sorted list.

Optionally, in step 1040, at least one of the interchangeable parts is set as default based on the comparison. For example, if a business process has three interchangeable steps and the first one is the default step, following the comparison the third step may be set as default. This may be done, for example, because an interchangeable part was found to arouse more positive emotional reactions than other interchangeable parts. In one embodiment, emotional states are detected for a group of users, and the at least one interchangeable part is set as default for the group of users.

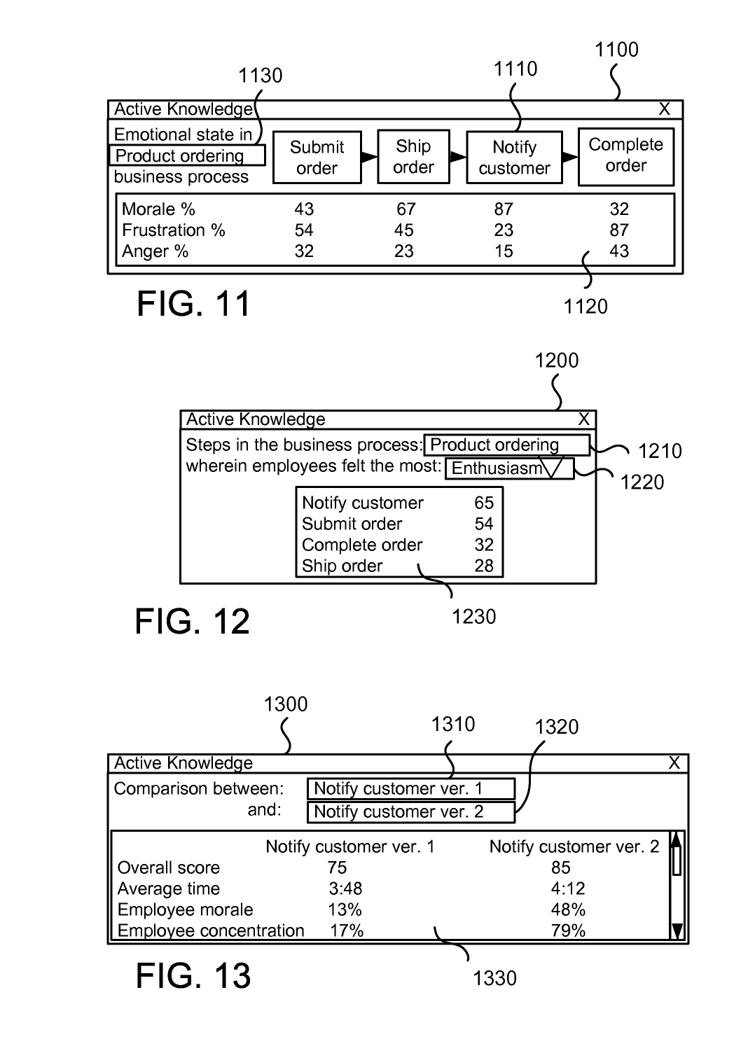

FIG. 11 is a schematic illustration of a screen display of informative window 1100 providing information about the average emotional state of employees in the specified business process (product ordering). A drop down menu 1130 allows a user of the informative window to specify a business process for which to receive information. A flowchart 1110 illustrates the different steps of the business process and a statistics window 1120 provides statistics for several user emotions correlated with the business process steps. The statistics are illustrated here as percentage values. Such values may represent various things, for example, a percentage of users who felt the specified emotion during the specified part of the business process, or an average intensity of a specified emotion felt by users during the specified part of the business process. In the example illustrated in FIG. 11, a feeling of frustration was detected in 54 percent of the users at the business process step of submitting an order. The statistics may also comprise other types of scores, scales and values. Statistical values may be more complex and may be represented in various ways such as by icons, graphical gauges, charts, etc.

FIG. 12 is a schematic illustration of a screen display of an informative window 1200 in accordance with an embodiment of the present invention. The informative window provides information about business process parts wherein a specified emotion is most strongly exhibited. A drop down menu 1210 allows a user of the informative window to specify a business process for which to receive information. This menu may, for example, have a choice of a group of business processes. Another drop down menu 1220 allows the user to specify an emotion or an emotional state comprising more than one emotion for which to receive information. A statistics window 1230 provides values correlated with corresponding business process parts, for example, in descending order. These values may be calculated using any statistics-based method.

FIG. 13 is a schematic illustration of a screen display of an informative window 1300 in accordance with an embodiment of the present invention. The illustrated informative window provides information about a comparison between two interchangeable business process parts. Two drop down menus, 1310 and 1320, allow a user of the informative window to specify the business process parts to compare. A statistics window 1330 provides a list of values correlated with each of the compared business process parts. The list may comprise values derived from detection of emotional states and other values that are not derived from emotional states of users. In the illustration, a value of an overall score is presented as the first value of the list. Such an overall score may be a function of other values in the list.

In one embodiment, more than two business process parts may be compared. The parts may be interchangeable parts of a business process or coexisting parts, and may be parts of different business processes. A comparison may be made between parts of any type, such as business process steps, fields, widgets or an aggregation or combination thereof. In one embodiment, business process parts from different types may be compared. For example, a business process field may be compared with a business process step.

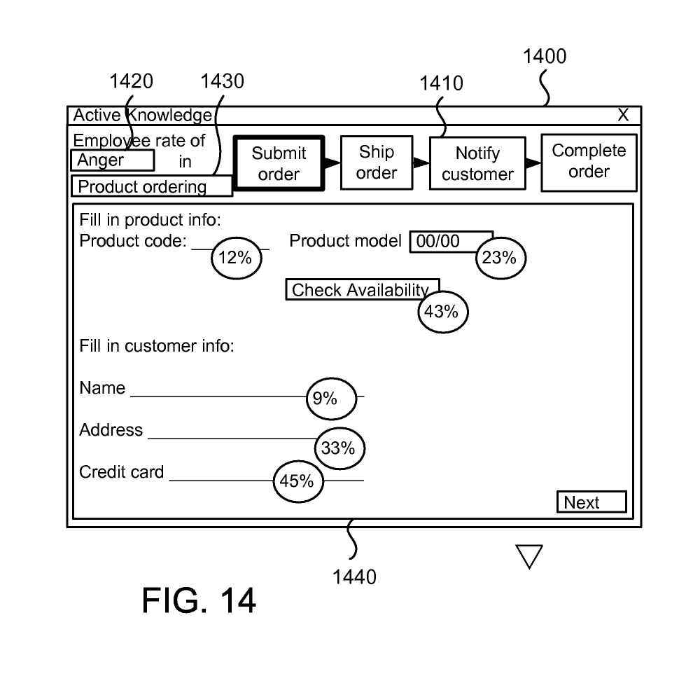

FIG. 14 is a schematic illustration of a screen display of an informative window 1400 in accordance with an embodiment of the present invention. The illustrated informative window provides information about the average emotional state of employees in the specified business process (product ordering). A drop down menu 1430 allows a user of the informative window to specify a business process for which to receive information. Another drop down menu 1420 allows the user to specify an emotion for which to receive information. A flowchart 1410 illustrates the different steps of the business process. The first step in FIG. 14 is selected. Selecting other steps will provide statistical information about parts of those other steps. A statistics window 1440 provides statistics for the specified emotion correlated with parts of the selected business process step. The statistical data may be presented by displaying a snapshot of the specified step of the business process and displaying statistical values next to corresponding parts of the business process step. In the illustrated example, the level of anger detected in users filling in the credit card entry field is 45 percent on a scale ranging from 0 (no anger) to 100 (very angry).

Referring again to FIG. 14, in one embodiment, statistical data regarding multiple emotional states may simultaneously be indicated for parts of the business process. For example, a snapshot of a specified business process step may display statistical data pertaining to both anger and alertness next to each corresponding part of the business process step. In one embodiment, other statistical data not pertaining to emotional states of users may be indicated for parts of the business process in addition to statistical data pertaining to emotional states. For example, a snapshot of a specified business process step may display, next to each part of the business process step, corresponding statistical data pertaining to both anger and the amount of time it takes to complete the part.

Referring again to FIG. 14, in one embodiment, an overall score may be generated which takes into account statistical values pertaining to several business process parts, and a user may indicate which parts of the business process should be taken into account when calculating the overall score. Thus, the effect of removing or modifying parts of a business process on the statistical data regarding the emotional states of employees performing the business process may be generated and displayed to the user. For example, an informative window may display an overall score regarding the level of anger of users performing a business process step, and a user may choose to view what the overall score will be if a problematic entry field, wherein users become extremely angry, is removed from the business process step.

In one embodiment, different parts of a business process may be assigned different weights when a score is calculated for a portion of the business process that comprises these parts. For example, a part that has a high importance to the business process or a part in which users spend more time may receive a higher weight in the calculation of the overall score.

Another aspect of the embodiments of the methods for providing emotional statuses in abstract representations of business processes is described herein. The term “emotional status of a business process part” as used herein refers to data pertaining to emotional states of users associated with the business process part. An emotional status of a business process part may comprise various statistics pertaining to emotions, data pertaining to different groups of users and/or different types of business process instances, etc. For example, an emotional status of a business process part may comprise data pertaining to an average level of morale of users who perform the business process part.

The terms “abstract representation of a business process”, “abstracted business process” and “abstract representation of a business process part” as used herein refer to a representation of a business process, or of a part thereof, wherein at least one element of the representation comprises a generalized, condensed, or simplified representation of at least one element of the underlying business process or part thereof. Examples of abstractions are: unifying elements of a business process into one element, modifying an element so that its meaning is more general than that of the unmodified element. In one embodiment, execution and other actions which may be performed upon original parts of the business process may be performed upon the abstract representation. An abstract representation or a part thereof may, for example, represent another abstract representation or a part thereof.

The term “abstract emotional status” as used herein refers to an emotional status pertaining to an abstract representation of a business process. It is to be understood that an abstract emotional status may be similar to a regular emotional status.

When an abstract part is generated from business process parts, an emotional status may be generated for the abstract part by using a function which operates on emotional statuses of the business process parts. This function may take into account the importance of each business process part, its average length, its relevancy to an organization for which the abstraction is generated, etc. Furthermore, if the emotional statuses of the business process parts were obtained by using some automatic method, the embodiments of this method may be altered or a new method may be initiated in order to maintain the emotional statuses associated with the abstract parts.

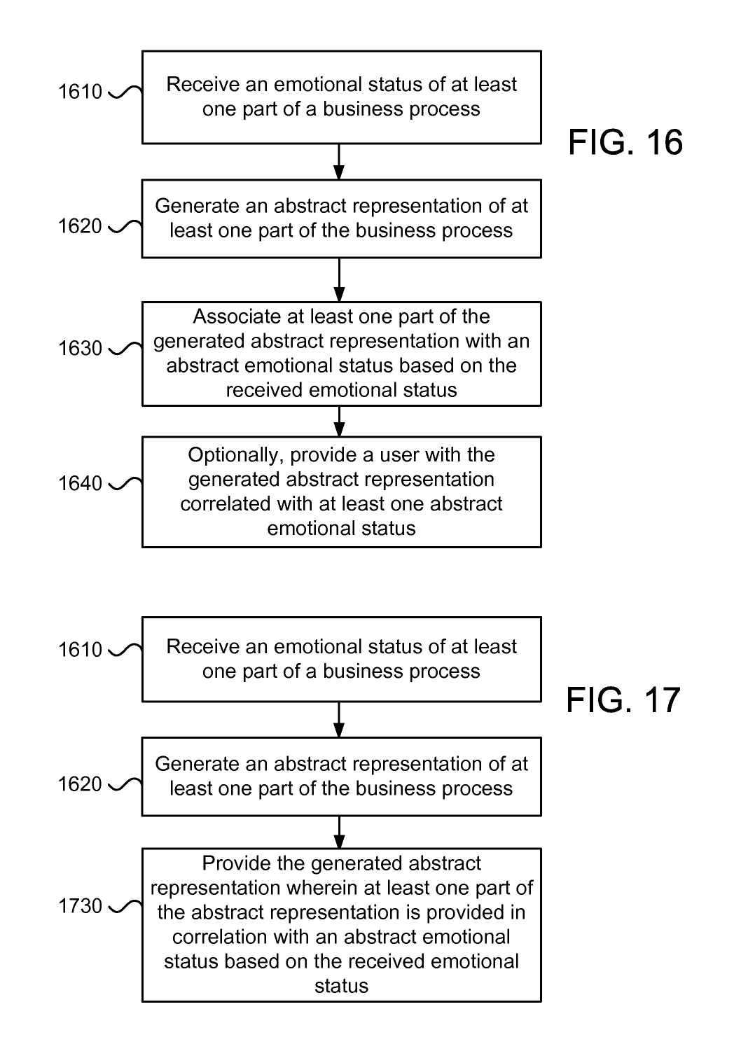

FIG. 16 illustrates one embodiment. In step 1610 an emotional status of at least one part of a business process is received. The emotional status may be received, for example, by accessing a database, or by directly detecting emotional states of monitored users. In step 1620 an abstract representation of at least one part of the business process is generated. An abstract representation may represent an entire business process. In one embodiment, an abstract representation may be generated by unifying parts of the business process wherein associated emotional statuses are similar. Two emotional statuses of business process parts may be considered similar if, for example, a difference in at least one element of each of the emotional statuses is below a certain threshold (e.g. the difference between two business process parts in the percentage of users who exhibit strong anger is less than 5%). When unifying business process parts into an abstract representation or into a part of an abstract representation, it may be possible to use only some elements of the business process parts.

In one embodiment, the business process may be shared by more than one organization. For example, a first organization may own the business process and a second organization may have access to some part of the business process. In another example, two or more organizations collaborate on a business process, each being responsible for a different part of the process. The abstract representation may be generated for use in at least one of the aforementioned organizations. It may be generated according to data relevant to the organization such as: parts of the business process owned by the organization, parts of the business process important to the organization, permissions associated with the organization, etc. In one embodiment, an emotional status associated with a business process of a first organization may be accessed by a second organization, which may decide, according to this and other data, whether to do business with the first organization. Thus, inter-enterprise collaboration may be enhanced.

The generated abstract representation may be operable, i.e. actions may be performed upon the abstract representation similarly to performing these actions upon the underlying business process or parts thereof.

In step 1630 at least one part of the generated abstract representation is associated with an abstract emotional status based on the received emotional status. For example, if the abstract representation is generated by unifying parts of the business process into abstract parts of the abstract representation, an abstract emotional status that is associated to one of these abstract parts may be generated by averaging the emotional statuses associated with the underlying unified business process parts.

Optionally, in step 1640, a user is provided with the generated abstract representation correlated with at least one abstract emotional status. For example, the user may be presented with a graphical representation of an abstracted business process wherein labels providing informative data pertaining to emotional statuses are attached to parts of the abstracted business process.

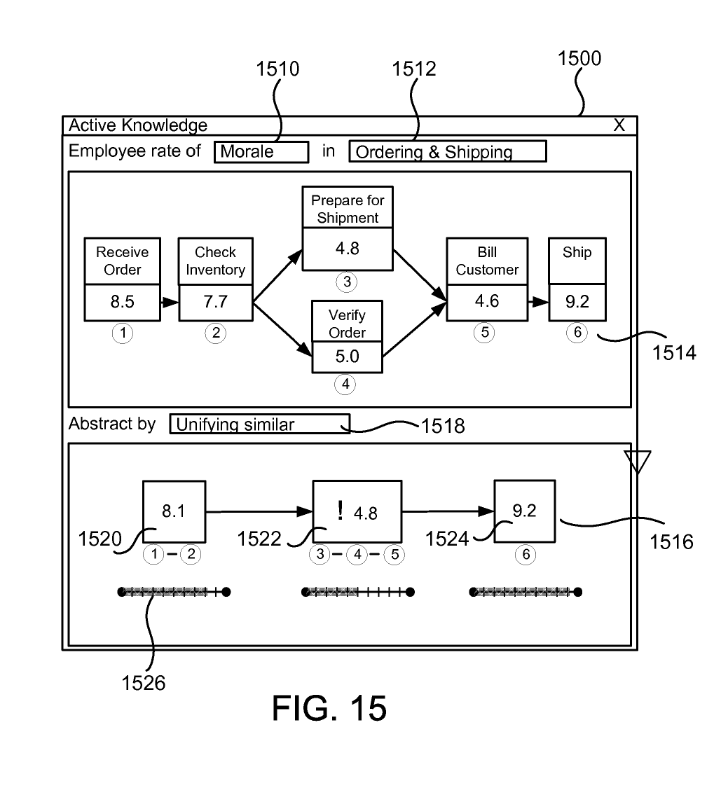

FIG. 15 is a schematic illustration of a screen display showing an informative window 1500 in accordance with an embodiment of the present invention. The illustrated informative window provides information about the emotional status of a business process. In the illustrated example, the average emotional state of employees in steps of the specified business process is provided. A drop down menu 1512 allows a user of the informative window to specify a business process for which to receive information. In the illustrated example, the chosen business is ‘ordering and shipping’. Another drop down menu 1510 allows the user to specify an emotion for which to receive information. In the illustrated example, the chosen emotion is morale.

The upper portion of the informative window provides a flowchart 1514 illustrating the different steps of the business process. Each of the steps may be provided along with statistical information pertaining to an emotional status of the step. In the illustrated example, the statistical information is the average morale level of the users associated with the business process step. In the illustrated example, the level of morale detected in users associated with the ‘bill customer’ step of the business process is 4.6 on a scale ranging from 0 (very low morale) to 10 (very high morale).

The lower portion of the informative window provides a flowchart 1516 illustrating an abstract representation of the business process. A drop down menu 1518 allows a user of the informative window to specify on what basis the abstract representation should be generated. In the illustrated example, the abstraction is generated by unifying steps of the business process wherein associated emotional statuses are similar. In one embodiment, the abstract representation may be based on other parameters, such as user role, organizations performing the business process parts, or any other predefined level of abstraction.

The abstract representation of the business process in the illustrated example is comprised of three abstract process steps. The first abstract step 1520 represents a unification of the first two steps of the underlying ‘Order and shipment’ business process. The second abstract step 1522 represents a unification of the third to fifth steps of the underlying business process, and the third abstract step 1524 represents the sixth step of the underlying process.

Each of the steps in the abstract representation of the business process may be provided along with statistical information pertaining to an emotional status of the step. In the illustrated example, the statistical information correlated with each abstract step is the average morale level of the users associated with its underlying business process steps. Thus, in the illustrated example, the level of morale indicated for the first abstract step 1520 is the average level of morale detected in users associated with the ‘Receive order’ and ‘Check inventory’ steps of the underlying business process.

In one embodiment, statistical information pertaining to an emotional status may be indicated using a textual or graphical indicator. In the illustrated example, the average morale level in each abstract step is also indicated by a graphical indicator 1526.

An abstract representation of a business process may be used to identify problematic parts of the process. Referring again to FIG. 15B, the abstract representation indicates that users' morale is high at the beginning and at the end of the underlying business process and low at the middle of the underlying business process. This is indicated by the high morale levels in the first and third abstract steps, 1520 and 1524, and the low morale level in the second abstract step 1522. In order to assist a user in identifying problematic parts, a warning sign may be provided to the user, such as the exclamation mark illustrated in the second abstract step 1522.

FIG. 17 illustrates one embodiment. In step 1610 an emotional status of at least one part of a business process is received. In step 1620 an abstract representation of at least one part of the business process is generated. The abstract representation may be generated, for example, by unifying at least two parts of the business process into an abstract part and associating it with an abstract emotional status according to emotional statuses of the unified parts. In step 1730 the generated abstract representation is provided to a user or as output to another program, wherein at least one part of the abstract representation is provided in correlation with an abstract emotional status based on the received emotional status.

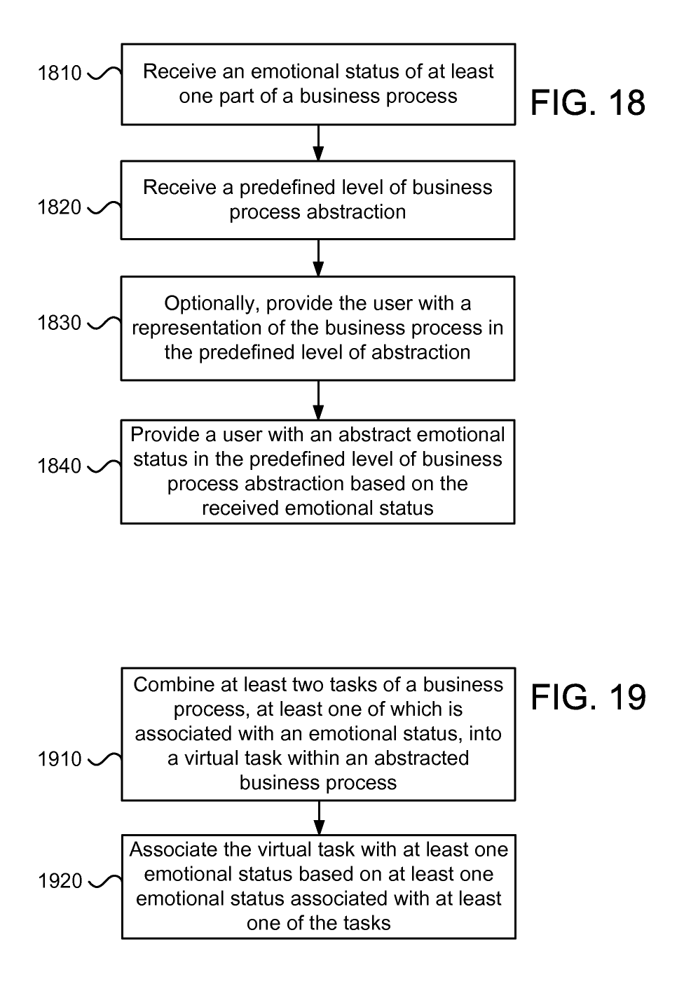

FIG. 18 illustrates one embodiment. In step 1810 an emotional status of at least one part of a business process is received. In step 1820 a predefined level of business process abstraction is received. The predefined level of business process abstraction may be defined by a user, automatically generated based on data such as the organization for which the business process should be abstracted, or received in any other way. In one embodiment, the level of business process abstraction defines rules according to which the business process should be abstracted. For example, these rules may indicate on what basis business process elements should be unified. These rules may also be defined by a user, automatically generated based on data such as the organization for which the business process should be abstracted, or received in any other way. In one embodiment, a level of abstraction may be associated with an organizational role, such that employees playing different roles are provided with different business process abstractions. For example, a top level manager, who should see a bigger picture of the business process, may be provided with a high level of abstraction, while a human-resource staff member may be interested in a low level of abstraction. In one embodiment, a level of abstraction may indicate that a business process abstracted according to it is comprised only of documentation and is made of abstracted parts each representing parts of the business process associated with a single electronic form.

Optionally, in step 1830, a user is provided with a representation of the business process in the predefined level of business process abstraction. This representation may be generated by means such as those mentioned above.

In step 1840 the user is provided with at least one abstract emotional status in the predefined level of business process abstraction based on the received emotional status. For example, if the user was provided with a representation of the business process in the predefined level of abstraction then the at least one emotional status may be provided in correlation with parts of the provided business process representation. In one embodiment, if the predefined level of abstraction corresponds to an abstracted business process comprised of 5 steps then the user will be provided with emotional statuses associated with those 5 steps.

FIG. 19 illustrates one embodiment. In step 1910 at least two tasks of a business process are combined into a virtual task within an abstracted business process. At least one of the tasks is associated with an emotional status. The tasks may be combined into the virtual task, for example, according to methods for generating an abstract representation of a business process mentioned above. In step 1930 the virtual task is associated with an emotional status based on at least one emotional status associated with at least one of the tasks comprising the virtual task. For example, the emotional status associated with the virtual task may be an average of the emotional statuses associated with those tasks. In one embodiment, the virtual task is linked to the at least two tasks such that an execution of the abstracted business process corresponds to an actual execution of the business process.

Another aspect of the embodiments of the methods for providing a user with an affective document is described herein. A document may, for example, be a word-processor document, a spreadsheet, an e-mail, an instant message, an SMS message, a digital image, a presentation document, a presentation slide, a map, a webpage, a webpage in an enterprise portal, an electronic form, a business process document, an animated movie such as a flash movie, etc. An element of the document may comprise any part or parts of the document, or the entire document. An element may comprise other elements. Document elements may be, for example, a textual element such as a paragraph, an image, a widget, a macro associated with the document, a window associated with the document, background of the document, document theme, web content such as a link, etc.

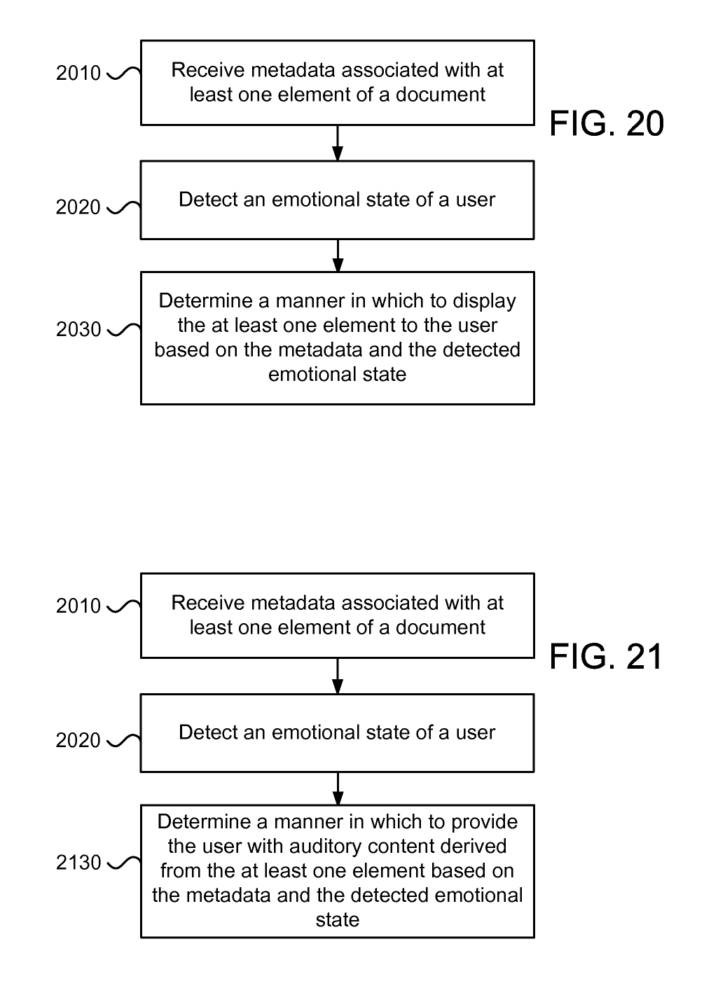

Referring to FIG. 20, in step 2010 metadata associated with at least one element of a document is received. The metadata may be, for example, part of the at least one element, part of the document, or of another document or standalone. The metadata may be indirectly associated with the at least one element. For instance, the document may be a PDF document and the metadata may be a script associated with a checkbox in a system preferences dialogue labeled ‘adapt font and color in my PDF files to my mood’. In one embodiment, the metadata comprises a tag associated with the at least one element. In another embodiment, the metadata associated with the at least one element comprises a rule, such as a business logic rule, which is based on an emotional state of a user. For example, such a rule may indicate that an element is to be hidden if the detected stress in a user's emotional state is above average. In another embodiment, the metadata may be associated with the entire document and may indicate which set of elements to display to the user as a function of the user's emotional state. In another embodiment, the metadata may comprise associations between emotional states and specifications for a manner in which to display the at least one element of the document.

In step 2020 an emotional state of a user is detected. In step 2030 a manner in which to display the at least one element to the user is determined based on the metadata and the detected emotional state. The manner in which to display the at least one element to the user may be, for example: displaying the element, not displaying the element, partially displaying the element, displaying the element in a specific format, displaying the element at a specific location in the document, displaying the element as read-only, displaying a specific view of the element, displaying the element in a specific language or terminology, displaying the element tailored to the user's emotional state, displaying the element as disabled or inactive, displaying the element at a specific level of detail, and displaying the element at a specific level of abstraction. In one embodiment, the document is a structured document, such as an electronic form. Such an electronic form may be used in a business process. The structured document may be comprised of consecutive steps, whereby in one step the emotional state of a user is detected and in another step the detected emotional state is used to determine a manner in which to display an element of the document. For example, in one embodiment, the user's emotional state may be detected while the user enters data to an entry field of an electronic form, and the detected emotional state may determine whether or not another entry field of the form will be presented to the user.

In one embodiment, the emotional state of the user may be detected by a component capable of detecting the emotional state that operates independently, having no direct association with the document or with a program associated with the document, and the program that provides the document may make use of the output of the emotion detection component. Such a component may, for example, be a service running in the system background, responsible for periodically detecting the emotional state of the user and making available the output of the detection.

The manner in which to display the at least one element may be determined based on other contextual data in addition to the detected emotional state of the user. This contextual data may be, for example, the user's role, active project, gender, expertise, experience or psychological profile, the environmental conditions, etc. For instance, the metadata may comprise rules which give a score to the context of the user based on the detected emotional state and other contextual data. For example, a positive emotional state may improve the score, whereas an approaching deadline of a project associated with the user may reduce the score. Consequently, based on the generated score, a manner in which to display an element of a document may be determined. For example, if the generated score is below a threshold, a field indicating project status in a document may turn red and display words of warning.

In one embodiment, the manner in which to display the at least one element of the document may be determined by first calculating an emotional state compatible with the received metadata and then determining the manner in which to display the element by comparing the detected emotional state with the calculated emotional state. For example, the received metadata may be a label of a text paragraph which is not directly related to emotion. Such a label may be, for example, ‘additional info’. A calculated emotional state compatible with this label may be, for example, ‘relaxed’. This emotional state may be compared with the detected emotional state, and they are close enough, i.e. the user is quite relaxed, a decision to display the text paragraph as part of the document may be made. Otherwise, the text paragraph may be displayed in small italic font or not displayed at all. In another embodiment, a function may exist which compares the received metadata with the detected emotional state and determines whether they are compatible. Based on this determination the manner in which to display the at least one element may be determined.

In one embodiment, the at least one element of the document may have two or more views and the manner in which the at least one element is displayed may comprise choosing at least one of the views. These views may be, for example, tabs in the document, and only tabs appropriate to the user's emotional state may be displayed to the user.

Referring to FIG. 21, in step 2010 metadata associated with at least one element of a document is received. In step 2020 an emotional state of a user is detected. In step 2130 a manner in which to provide the user with auditory content derived from the at least one element is determined based on the metadata and the detected emotional state. In one embodiment, the auditory content may be speech, and it may be derived from the at least one element by using a text-to-speech component. The manner in which to provide the user with the speech may be a characteristic of the speech, such as intonation, gender, age or accent of the speaker. For example metadata associated with a text paragraph may indicate that the text should be read more slowly to a user whose emotional state shows lack of concentration. In one embodiment, the auditory content may be a sound effect.

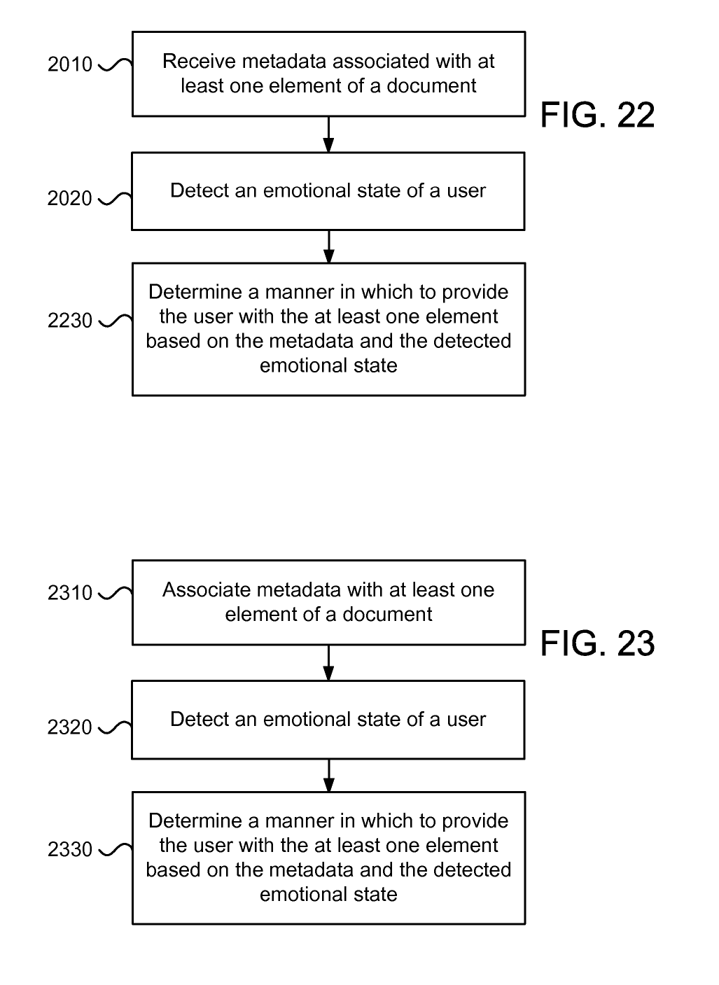

FIG. 22 illustrates one embodiment. In step 2010 metadata associated with at least one element of a document is received. In step 2020 an emotional state of a user is detected. In step 2230 a manner in which to provide the user with the at least one element is determined based on the metadata and the detected emotional state. In one embodiment, the at least one element may be provided to the user by displaying the at least one element. In another embodiment, the at least one element may be provided to the user by providing the user with auditory content derived from the at least one element.

FIG. 23 illustrates one embodiment. In step 2310 metadata is associated with at least one element of a document. The association of the metadata may be determined manually, semi-automatically or automatically. Metadata may be associated, for example, by labeling the element. In one embodiment, this labeling is performed by an automatic process which analyses the at least one element to determine keywords or topics and uses these keywords or topics to label the at least one element. In step 2320 an emotional state of a user is detected. In step 2330 a manner in which to display the at least one element to the user is determined based on the metadata and the detected emotional state.

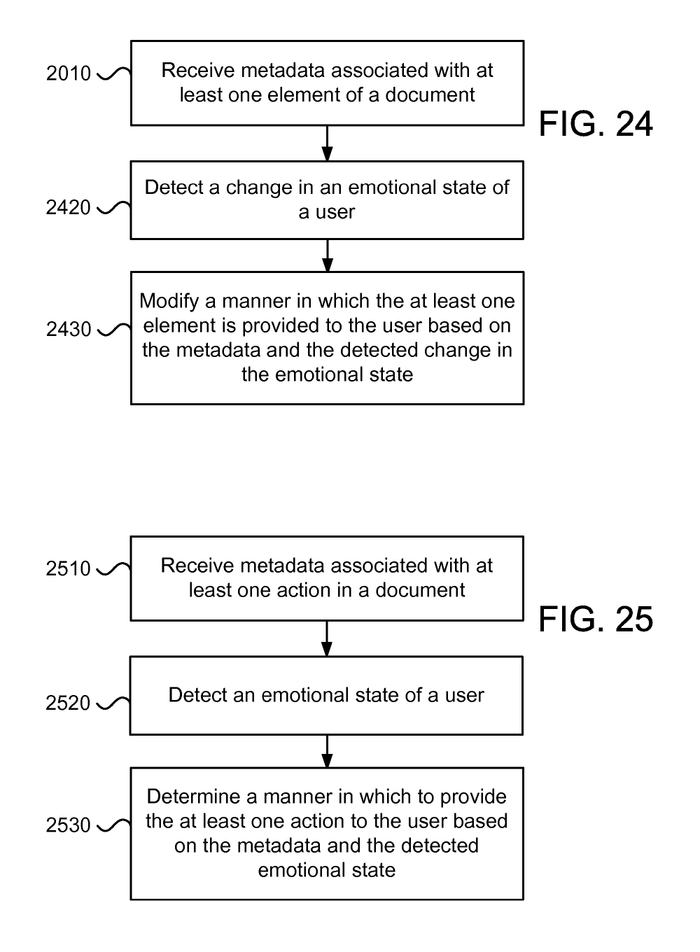

FIG. 24 illustrates one embodiment. In step 2010 metadata associated with at least one element of a document is received. In step 2420 a change in an emotional state of a user is detected. The change may be detected, for example, by comparing a detected emotional state of a user with an emotional state detected for the user at a previous time. In step 2430 a manner in which the at least one element is provided to the user is modified based on the metadata and the detected change in the emotional state. For example, a button may be provided as disabled due to metadata associated with the button specifying that when the user is in the detected emotional state it is best not to allow the user to perform an action associated with the button. In this case, when a change in the emotional state of the user is detected, the button may become enabled. In one embodiment, the emotional state of the user is monitored, i.e. detected periodically, and the manner in which documents and elements thereof are provided to the user may be modified in real-time following changes in the emotional state of the user. Modifying the manner in which an element is provided may comprise providing an unprovided element, ceasing to provide a provided element or changing the manner in which an element is provided to any of the manners in which elements may be provided previously described.

FIG. 25 illustrates one embodiment. In step 2510 metadata associated with at least one action in a document is received. An action in a document may be an action performable using an element in the document such as a widget, a link, a script, etc. In step 2520 an emotional state of a user is detected. In step 2530 a manner in which the at least one action is provided to the user is modified based on the metadata and the detected emotional state. For example, the action may be following a link to the destination of the link such as a webpage, and determining the manner in which the action is provided may be determining the destination of the hyperlink. In another example, the action may be performed using a widget which is associated with two or more scripts and determining the manner in which the action is provided may comprise choosing one of the scripts, so that when a user interacts with the widget the chosen script is activated. The manner in which to provide an action may be, for example, providing the action disabled, providing the action enabled, providing a modified version of the action, providing the action with specific parameters, providing the action partially enabled, etc.

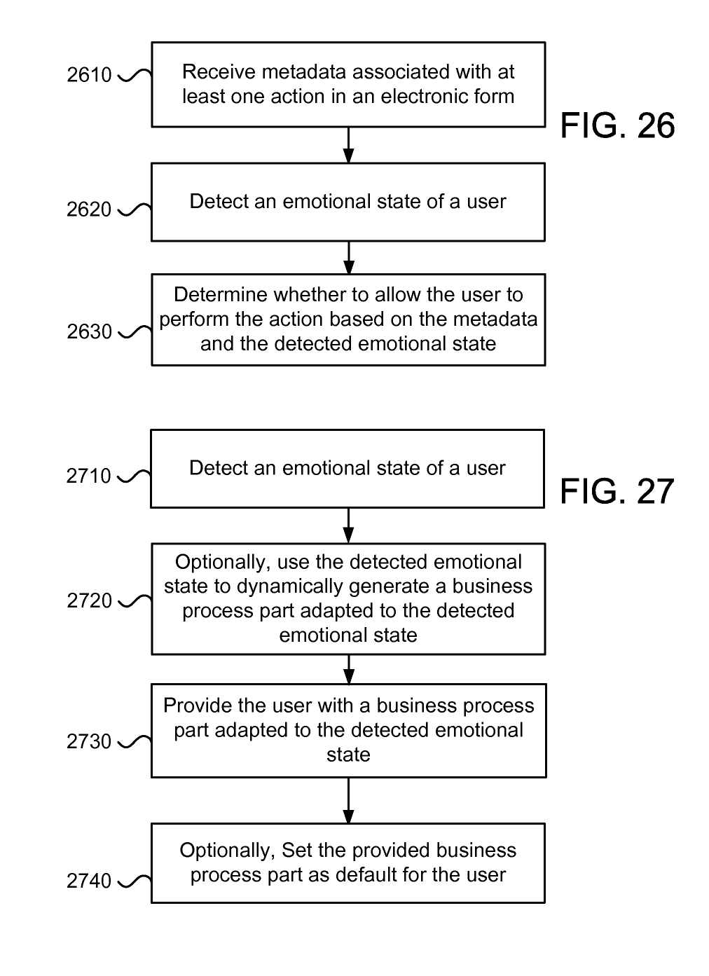

FIG. 26 illustrates one embodiment. In step 2610 metadata associated with at least one action in an electronic form is received. The electronic form may be used in a business process, and the action may be a business process related action. For example, the electronic form may be a form related to the business process of dismissing an employee and the action may be an approval of the process. In step 2620 an emotional state of a user is detected. In step 2630 it is determined whether to allow the user to perform the action based on the metadata and the detected emotional state. In one embodiment, the metadata may comprise criteria for an emotional state the user should be in to be allowed to perform the action. If the detected emotional state of the user does not meet the criteria, the user may not be allowed to perform the action. For example, the action may be disabled for the user or not provided to the user at all.

FIG. 27 illustrates one embodiment. In step 2710 an emotional state of a user is detected. Optionally, in step 2720, the detected emotional state is used to dynamically generate a business process part adapted to the detected emotional state. A business process part is previously defined. For example, it may be a document such as an electronic form associated with the business process. In one embodiment, the adapted business process part is generated following a logic which may be predefined, specified in metadata associated with the business process part, stored in a configuration file or determined in any other way. For example, a business process may comprise a set of two or more interchangeable parts and metadata may be associated with the business process or with the set of parts describing which parts are appropriate to which emotional states. Dynamically generating an adapted business process part may comprise choosing one of the interchangeable parts that is appropriate for the detected emotional state of the user based on the aforementioned metadata. In step 2730 the user is provided with a business process part adapted to the detected emotional state. A business process part may be adapted to the detected emotional state by determining a manner in which to provide the business process part to the user according to the previously described methods. The adaptation may take into account parameters other than the detected emotional states. These parameters may be parameters related to the business process, such as the current state of the business process, the current running mode of the business process, the current role of the user, etc. Optionally, in step 2740, the provided business process part is set as default for the user. For example, an association may be made between the manner in which the business process part was provided and the user, and in following instances of the business process the user will be provided with the business process part in a similar manner. This association may be made, for example, by a component which monitors emotional states or productivity-related parameters of users and sets a specific manner in which a business process part is provided as default if a user exhibits high productivity or positive emotional states when provided with the business process part in such a manner. This association may be made, for example, by a component which monitors emotional states or productivity-related parameters of users, and, if a user exhibits high productivity or positive emotional states when provided with a business process part in a specific manner, sets the specific manner in which the business process part is provided as default.

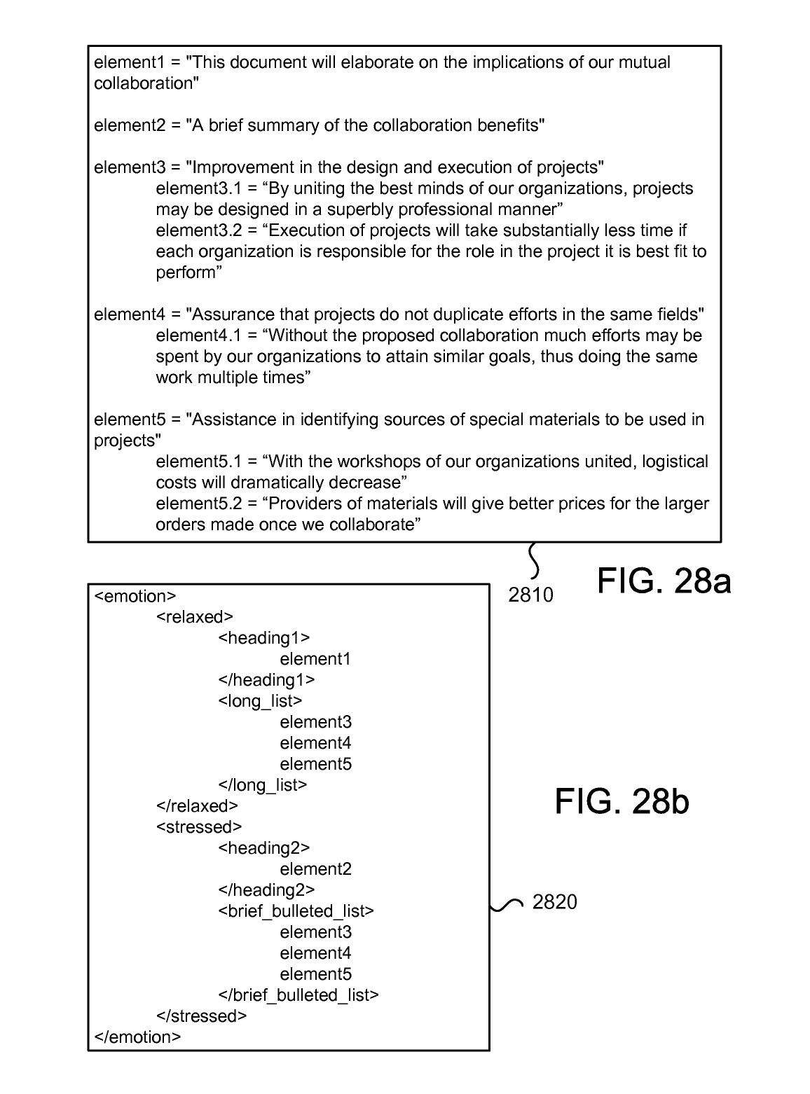

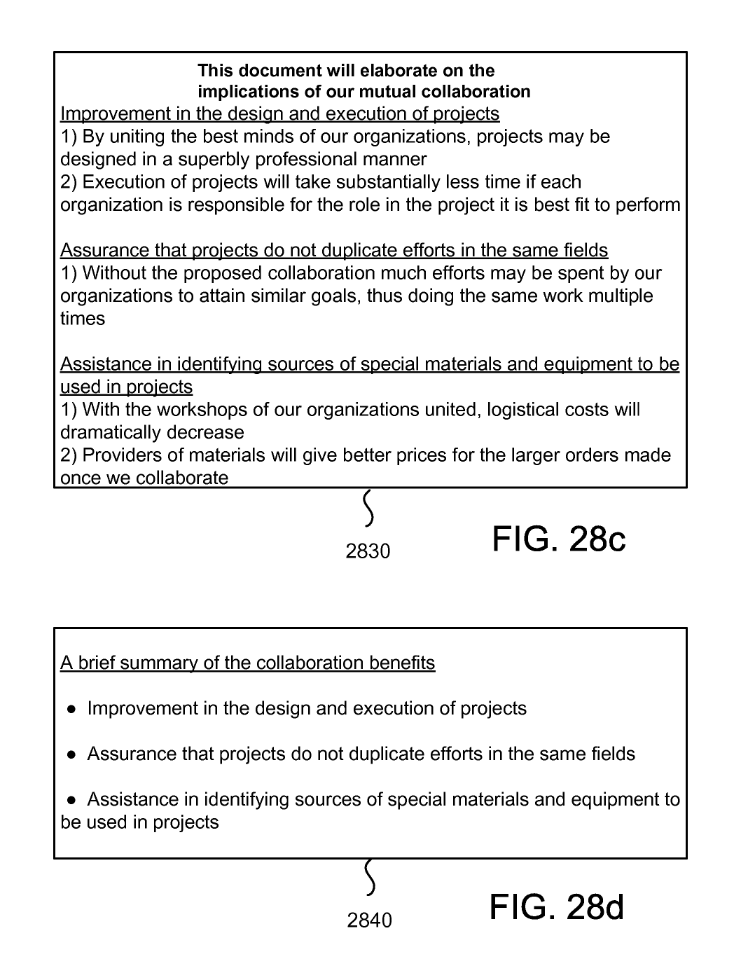

FIGS. 28a-28d are schematic illustrations of document structure and display according to one embodiment.

FIG. 28a illustrates a tree of elements 2810 of a part of a document according to one embodiment. In this example, all of the elements are character strings and elements 3-5 each have one or two sub-elements (i.e. elements with a parent-child relationship in the elements tree).

FIG. 28b illustrates metadata associated with the document 2820 according to one embodiment. In this example, the metadata is in the form of tags, though in other embodiments of the invention it may be in other forms. The following tags are named and structured in an illustrative manner, which is not meant to limit the scope of the invention. The tag <emotion> encloses metadata related to the emotion-sensitive part of the document. Inside, there are two tags <relaxed> and <stressed>. According to one embodiment, when providing the illustrated document to a user, the emotional state of the user is detected and a part enclosed by either of the two tags is provided accordingly. In other embodiments there may be other tags corresponding to data produced by an emotional state detecting component.

In this example, there are two differences between the manner in which the illustrated document part is provided to a relaxed user and the manner in which it is provided to a stressed user. First, a relaxed user is provided with “element1” formatted by the <heading1> tag, whereas a stressed user who is provided with “element2” formatted by the <heading2> tag. Second, a relaxed user is provided with elements 3-5 in the format defined by the <long_list> tag, and a stressed user is provided with these elements in the format defined by the <brief_bulleted_list> tag. According to the format defined by the latter tag sub-elements of the listed elements are not provided to the user.

FIG. 28c illustrates the document as it is provided to a user whose detected emotional state is determined to be relaxed according to one embodiment.

FIG. 28d illustrates the document as it is provided to a user whose detected emotional state is determined to be stressed according to one embodiment.

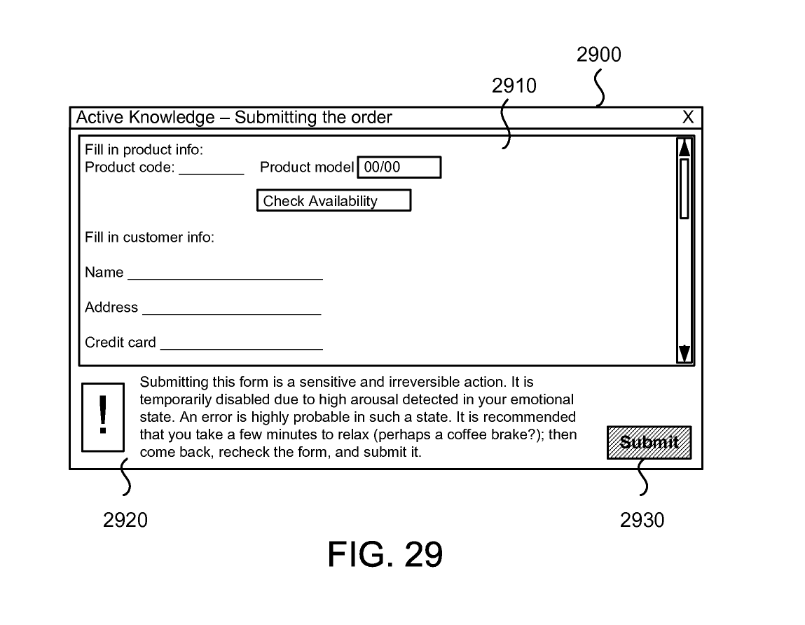

FIG. 29 is a schematic illustration of a screen display showing an electronic form 2900 according to one embodiment. The main window 2910 allows a user to fill in fields and perform other actions relevant to the form. The action of submitting the form 2930 is disabled and a message 2920 is displayed explaining why the action is disabled. In one embodiment, the emotional state of the user may be detected prior to presenting the form to the user. According to metadata associated with either the form, the ‘submit’ action 2930, the message 2920, or a combination thereof, a user with the detected emotional state is to be provided with the form wherein the message 2920 is visible and the ‘submit’ action 2930 is disabled. In one embodiment, a detected change in the emotional state of the user may cause the message to disappear and the action to become active. There may be a predefined delay between the detection of change in the emotional state and the changing of the form.

Another aspect of the embodiments of the methods for emotion induction in business process environment is described herein. Users performing a business process perform different types of tasks. Performing a task in an optimal manner may require the user to be in a specific emotional state. For example, performing a creative task may require that the user be in a happy mood, while filling a spreadsheet with numerical data may require a very concentrated state of mind suitable for monotonic work and may be performed while the user is in a bad mood. Such different types of tasks may be performed by different business process users or by the same user at different times. An emotional state may be induced on a user by changing the user's environment. For example, changing workspace lighting and background music is known to affect a person's mood. Thus, in order to optimize user work, it may be beneficial to induce on a business process user an emotional state appropriate for the current task the user is performing.

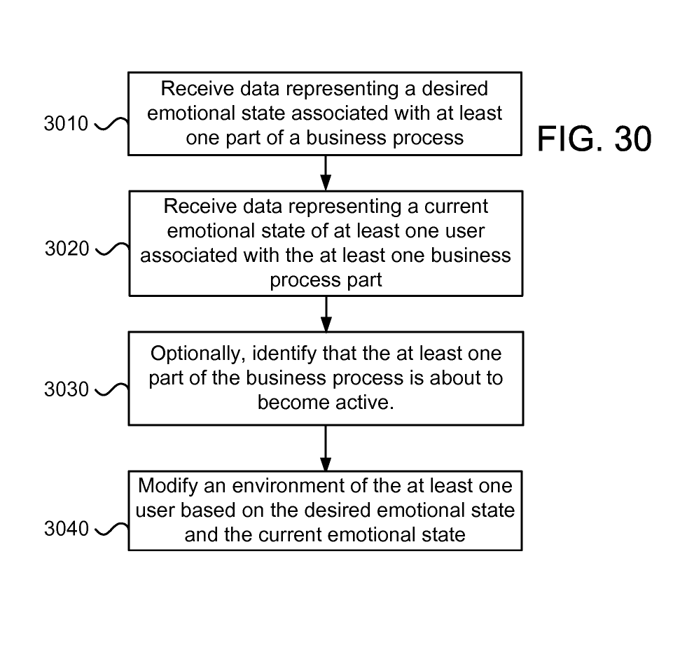

FIG. 30 illustrates one embodiment. In step 3010 data representing a desired emotional state associated with at least one part of a business process is received. A part of a business process may be, for example, a business process step, an entry field in a business process, a widget such as a drop down menu, an activity related to a business process, a document related to a business process, an entire business process or any number or combination thereof. A business process may be broken into parts in more than one way and using more than one strategy. For example, in a business process comprised of business process steps which represent the different sequential screens of the business process the process steps may be considered as parts of the business process. As another example, every field of a business process may be considered as a distinct part. Data representing a desired emotional state is associated with the at least one business process part. This data may be any data from which an emotional state may be derived. For example, it may be an integer value representing an emotional state, or it may be a set parameters related to an emotional state, such as parameters of an environment control system that may be used to induce the emotional state. Such an environment control system is discussed elsewhere in this disclosure. In one embodiment, the at least one part of a business process is a part of an electronic form associated with the business process, and the data representing the desired emotional state comprises metadata associated with the part of the electronic form. This metadata may, for example, be a tag specifying an emotional state, or it may be a business logic segment that is responsible for inducing the emotional state on a user who is associated with the electronic form.

In one embodiment, the desired emotional state is an emotional state that is optimal for performance of at least one activity relevant to the at least one part of the business process. The optimal emotional state may be, for example, predefined by a person such as the person who designed the business process. Alternatively, the optimal emotional state may be automatically calculated by comparing performance of users of the business process, in different emotional states. In one embodiment, the optimal emotional state for performing an activity in a business process may be different for different users. Accordingly, the desired emotional state may be dynamically generated for every user, for example, by accessing a profile of the user wherein desired emotional states for parts of the business process are specified.

The data representing the desired emotional state may be received from an instance of the business process. For example, business logic associated with an instance of the business process may be responsible for transmitting the data representing the desired emotional state to a process that implements one embodiment.

In step 3020 data representing a current emotional state of at least one user associated with the at least one business process part is received. This data may, for example, be received form a process responsible for detecting emotional states of users. The current emotional state may be a recent evaluation of a user's emotional state generated by such a process. The at least one user that is associated with the business process may, for example, be a user that is to perform an action that is relevant to a part of the business process, such as sending a letter, analyzing a spreadsheet, generating a report, etc. For instance, it may be a user whose current role in the business process implies performance of the action.

Optionally, in step 3030, it is identified that the at least one part of the business process is about to become active. In one embodiment, the business process may be made up of sequential tasks, and a part of the business process may be identified as about to become active if the task immediately before it is currently being performed or is close to completion. In the case of a business process made of business process steps, for example, a step may be identified as about to become active if a previous step is close to completion. A business process step that is close to completion may be, for example, a business process step that takes an average of 20 minutes to complete, and that has been active for 18 minutes. A business process step may also be close to completion if, for example, it is made up of several tasks and all the tasks but the last task have been performed.

In step 3040 an environment of the at least one user is modified based on the desired emotional state. In one embodiment, the at least one user may be an employee situated in a workspace, and the environment may correspondingly be a workspace environment. In one embodiment, prior to modifying the environment, an association between the at least one part of the business process and the at least one user may be identified. The association may be identified, for example, by determining that an instantiation of the at least one part of the business process is scheduled to occur in a proximate time, and that the at least one user is associated with the instantiation. In one embodiment, modifying an environment may comprise affecting at least one of the following: background noise, background music, lighting configuration and intensity, temperature, humidity, room design and configuration, furniture arrangement, decorations, etc. The environment of the at least one user may be modified by setting an environment configuration that attempts to shift the emotional state of the at least one user from the current emotional state to the desired emotional state. Methods for shifting emotional states of users by modifying their environment are known in the art.

In one embodiment, an environment of at least one user associated with the at least one business process part is modified. In the case where only one user is associated with the at least one business process part, and the user has a private workspace, only the user's private environment should be modified. If the user's environment is shared with another user, the environment may be modified in a way that takes into account the other user. For example, if several users share an environment, and each of the users needs different environmental conditions in order to best perform his or her work, then a system in accordance with the present invention may determine the optimal environmental conditions to maximize the performance of all the users. For example, if one user should be in certain lighting conditions and another user in other lighting conditions, the system may modify their environment to an average of the two lighting conditions. In the case where more than one user is associated with the at least one business process part, a system in accordance with the present invention may modify the environments of all these users. Again, if a user shares an environment with other users, the modification of the environment may take into account all of the users.

In one embodiment, the environment may be modified by an environment control component that has two or more modes of environment control. A mode of environment control may be, for example, a set of parameters for the environment control, such as a specific temperature, a specific humidity, etc. The environment may be modified by choosing a mode of environment control for the environment control component to work with.

In one embodiment, modification of the environment of a user may be based on a profile associated with the user. Modifying the environment of users to shift their emotional states to a desired emotional state may be considered as an emotion induction method. Different users may be vulnerable to different emotion induction methods and configurations thereof. These vulnerabilities may be stored in profiles of the users, and the profiles may be used to determine which emotion induction method and configuration thereof to use in order to induce a desired emotion on the user. For example, if the desired emotional state for a part of a business process in which the user is engaged is “Concentrated mood”, a profile associated with the user may indicate that low temperature, high humidity and quiet music may induce this emotional state on the user, and the environment may be modified accordingly.

In one embodiment, the environment may be modified a predefined period of time prior to the time when the at least one part of the business process becomes active. For example, an emotional state associated with a business process part may be induced on a user by modifying the user's environment, and the induction may occur when the user is engaged in another business process part that precedes the first business process part. The induction may occur an approximated time prior to activation of the business process part, for example, approximately 15 minutes prior to activation of the part. A business process part may be considered activated, for example, if interaction is identified between a user and an electronic form associated with the business process part. The aforementioned predefined period of time may be dynamically calculated based on the desired emotional state and the current emotional state of a user. For example, if the user's emotional state is far from the desired emotional state, the environment may begin inducing the desired emotional state a longer period of time prior to the activation of the business process part. In one embodiment, the predefined period of time may be determined based on a profile associated with the user. For example, if a user's profile indicates that it takes a long time to induce an emotional state on that user, the environment may begin inducing the emotional state a longer period of time prior to the activation of the business process part. In one embodiment, the environment modification may be performed differently for different predefined periods of time. For example, in order to induce a desired emotional state within a shorter predefined period of time, the induction may be configured to be more intense. For instance, if the emotional state that is to be induced requires lowering the temperature, it may be lowered faster.

In one embodiment, steps of the method illustrated in FIG. 30 may be repeated during execution of the business process. For example, the step of receiving data representing the current emotional state of at least one user, and the step of modifying the environment, may be repeated periodically, for instance, every 5 minutes. Repeating these steps allows constant monitoring of emotional states of users and respective modification of the environment. The step of receiving data representing a desired emotional state associated with at least one part of a business process may also be repeated, so that when a user starts working on a part of a business process wherein a new emotional state is desired, the environment may be modified to induce the new desired emotional state.

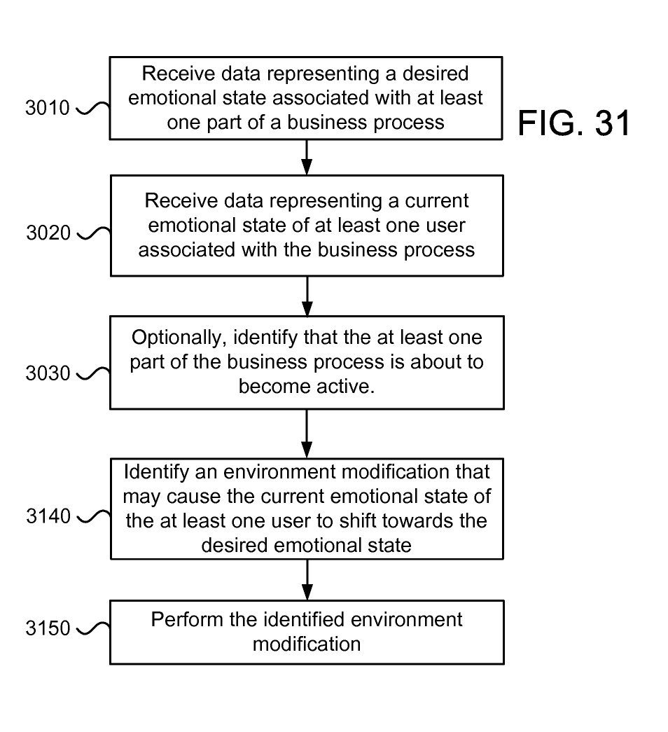

FIG. 31 illustrates one embodiment. In step 3010 data representing a desired emotional state associated with at least one part of a business process is received. In step 3020 data representing a current emotional state of at least one user associated with the business process is received. Optionally, in step 3030, it is identified that the at least one part of the business process is about to become active. In step 3140 an environment modification that may cause the current emotional state of the at least one user to shift towards the desired emotional state is identified. In one embodiment, a database may exist that defines for every current emotional state and for every desired emotional state, an environment modification that may shift a user's emotional state from the current state to the desired state. In one embodiment, data representing the desired emotional state and data representing the current emotional state of the at least one user may be compared. Based on differences between the current and the desired emotional states an appropriate environment modification may be determined. For example, if the aforementioned emotional states are represented as biometric data corresponding to the emotional states, and a considerable difference is identified in a parameter such as skin temperature, the determined environment modification may comprise changing the temperature of the room. This example may be applicable to biometric parameters that are capable of indicating an emotional state of a user as well as being affected by environmental changes. In step 3150 the identified environment modification is performed.

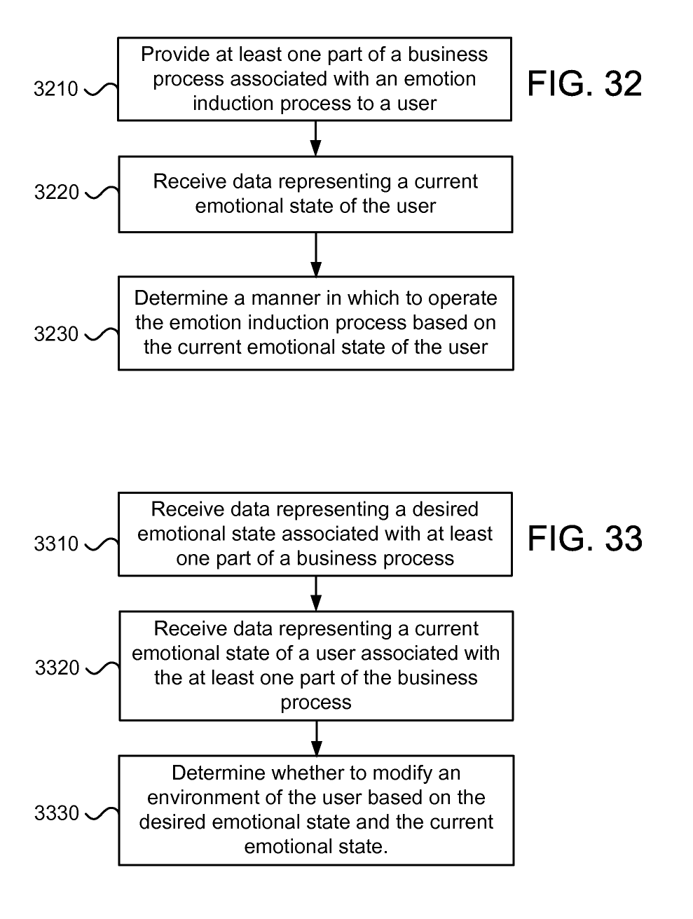

FIG. 32 illustrates one embodiment. In step 3210 at least one part of a business process associated with an emotion induction process is provided to a user. The association with the emotion induction process may, for example, be in the form of metadata or business logic rules associated with the at least one part. These rules or metadata may be used by the emotion induction process as parameters or guidelines. In step 3220 data representing a current emotional state of the user is received. The user may be a user of the at least one part of the business process that is provided. In step 3230 a manner in which to operate the emotion induction process is determined based on the current emotional state of the user. In one embodiment, the at least one part of the business process may be associated with rules specifying emotional states, users, and circumstances in which to induce the emotional states on the users. The circumstances may be, for example, current emotional states of users or parameters of the at least one business process part. Thus, if current emotional states of users change, the emotion induction process may be operated in a different manner. The emotion induction process may be operated in coordination with the at least one part of the business process. For example, if parameters of the at least one part change, the emotion induction process may be operated in a different manner.

The manner in which the emotion induction process operates may be, for example, a choice of a target for the emotion induction, a choice of an emotional state to induce, or a level of intensity for the emotion induction. The level of intensity may, for example, be based on the difference between the current emotional state of the user and an emotional state that the emotion induction process is to induce.

FIG. 33 illustrates one embodiment. In step 3310 data representing a desired emotional state associated with at least one part of a business process is received. In step 3320 data representing a current emotional state of a user associated with the at least one part of the business process is received. In step 3330 it is determined whether to modify an environment of the user based on the desired emotional state and the current emotional state.

In one embodiment, the desired emotional state may be compared with the current emotional state, and if a difference between the two states is greater than a predefined threshold a decision to modify the environment may be made. Otherwise, it may be determined that no modification is to be made to the environment. In one embodiment, both the desired emotional state and the threshold may be personalized to a user or to a group of users. This personalization may be made based on a profile associated with the user or with the group of users. In one embodiment, the desired emotional state and the current emotional state may be associated with, or even be comprised of, physiological data parameters specifying the emotional states. The two emotional states may then be compared, for example, by comparing the physiological data parameters. In one embodiment, an environment may be modified only if the difference in a physiological data parameter, such as skin conductivity, between the two emotional states is greater than a predefined threshold. The threshold may, for example, be defined automatically by a program that monitors employee performance in various emotional states, and determines thresholds for various physiological data parameters based on differences in average employee performance when these parameters are different.

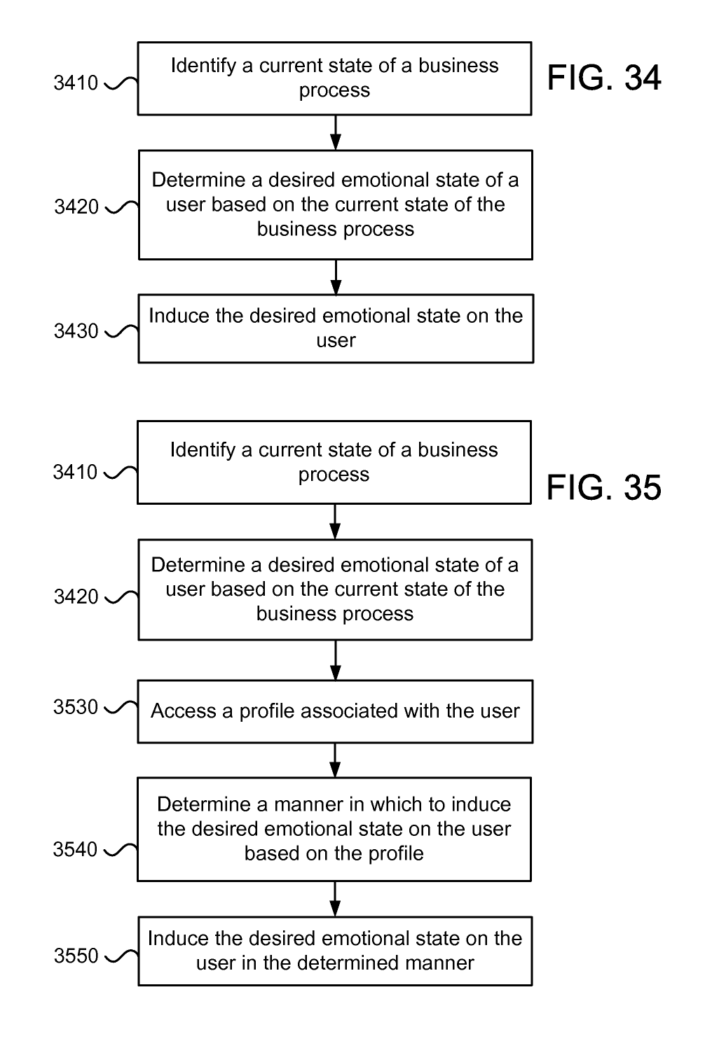

FIG. 34 illustrates one embodiment. In step 3410 a current state of a business process is identified. The current state of the business process may comprise any of the following: data relevant to currently active parts of the business process, values of parameters related to the business process, current state of documents relevant to the business process such as electronic forms, current state of business logic segments associated with the business process, etc. In step 3420 a desired emotional state of a user is determined based on the current state of the business process. The desired emotional state may be determined, for example, using metadata associated with the current state of the business process, such as metadata that specifies an emotional state and that is associated with an active part of the business process. In one embodiment, the desired emotional state may be calculated using values of parameters related to the business process. For example, a database may exist that defines desired emotional states for different values of business process parameters. Values may further be assigned with different weights. For instance, the database may define that if a value of a parameter specifying urgency of an instance of a business process is ‘very urgent’, then the desired emotional state for this value is an emotional state of urgency and the value is assigned with a higher weight when calculating the overall desired emotional state of the user. Consequently, the overall desired emotional state of a user corresponding to the state of the business process may be determined, for example, by averaging the desired emotional states of the different values according to their weights. In step 3430 the desired emotional state is induced on the user. Methods for inducing emotional states on users are known and evolving in the art.

In one embodiment, the desired emotional state is induced on the user by modifying an environment of the user.

FIG. 35 illustrates one embodiment. In step 3410 a current state of a business process is identified. In step 3420 a desired emotional state of a user is determined based on the current state of the business process. In step 3530 a profile associated with the user is accessed. The profile may, for example, comprise data specifying how best to induce various emotional states on the user in various circumstances. In another example, the profile may be a psychological profile of the user, specifying user traits such as whether the user is extroverted or introverted, long-term temperament, etc. The psychological profile may be used to determine the best approach when inducing an emotional state on the user. In step 3540 a manner in which to induce the desired emotional state on the user is determined based on the profile. In one embodiment, more than one method may be available for inducing a desired emotional state on a user. Accordingly, a manner in which to induce the desired emotional state may comprise a choice of at least one emotion induction method. In one embodiment, an emotion induction method may be configured in more than one way, for example, it may receive different parameters. Accordingly, a manner in which to induce the desired emotional state may comprise a choice of at least one configuration for an emotion induction method. In one embodiment, determining the manner in which to induce the desired emotional state on the user may be further based on other parameters such as: a current emotional state of the user, the desired emotional state to induce, the current state of a business process associated with the user, or any combination thereof. The accessed user profile may comprise guidelines for choosing the emotion induction manner based on these parameters. For example, the accessed profile may comprise a guideline specifying that if the user is in an emotional state ‘A’ and the desired emotional state is ‘B’, then emotion inducing method ‘C’ with the configuration ‘D’ should be used. In step 3550 the desired emotional state is induced on the user in the determined manner.

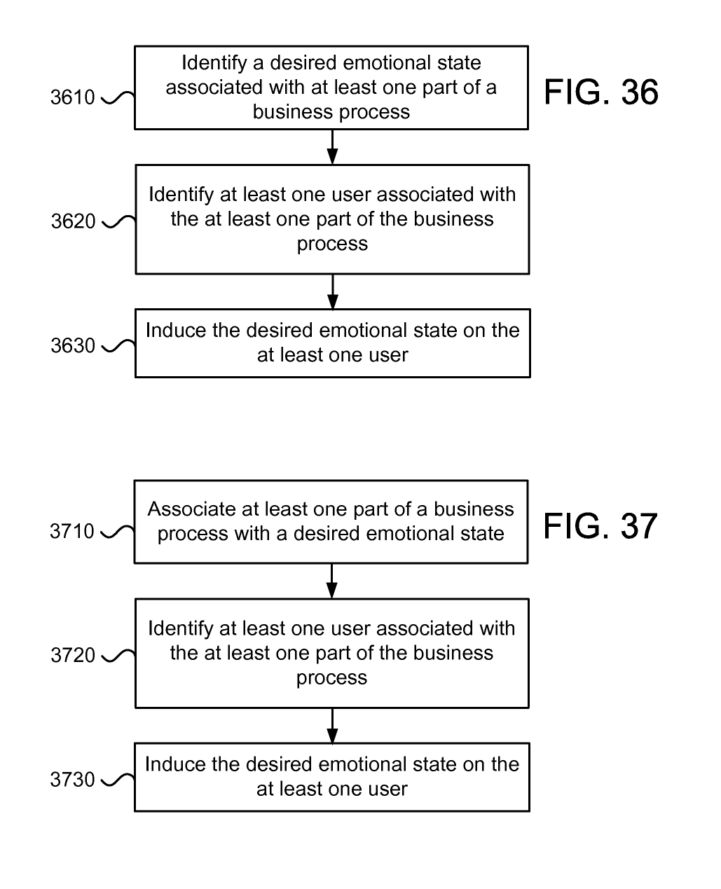

FIG. 36 illustrates one embodiment. In step 3610 a desired emotional state associated with at least one part of a business process is identified. In step 3620 at least one user associated with the at least one part of the business process is identified. For example, the at least one part of the business process may be associated with a specific role, and identifying a user associated with the at least one part may comprise determining which user is associated with the aforementioned role. In step 3630 the desired emotional state is induced on the at least one user.

FIG. 37 illustrates one embodiment. In step 3710 at least one part of a business process is associated with a desired emotional state. In one embodiment, the association may be made by attaching metadata to the at least one part of the business process, for example, by a person responsible for designing the business process. The metadata may, for instance, specify an emotional state that is desired for optimal user performance in a part of the business process. In another example, the metadata may specify that the emotional state should be induced a certain period of time prior to activation of the business process part. In step 3720 at least one user associated with the at least one part of the business process is identified. In step 3730 the desired emotional state is induced on the at least one user.

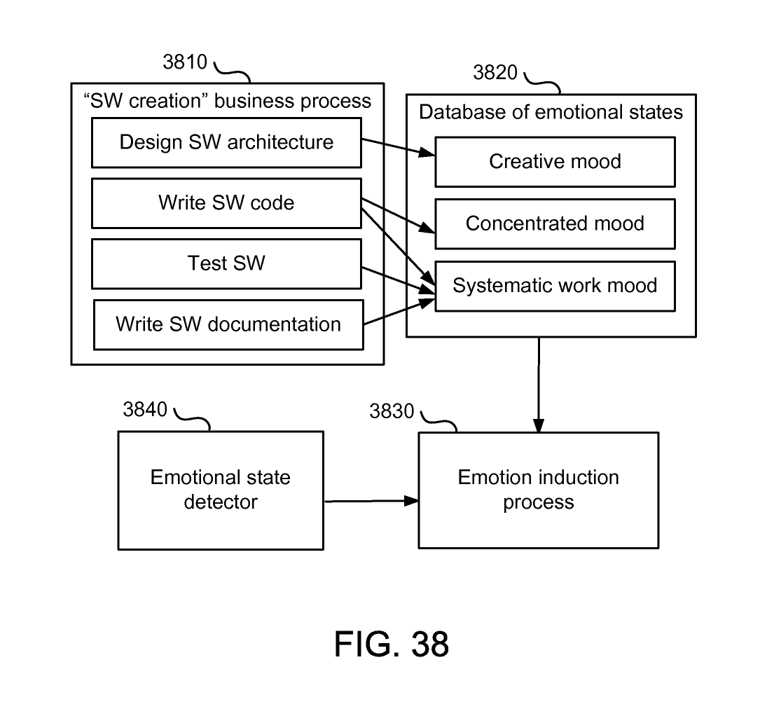

FIG. 38 is a schematic illustration of a business process based emotion induction system according to one embodiment.

The illustration comprises one architecture of a system, and is not meant to limit the scope of the invention.

Illustrated is a business process for software creation 3810 comprising four parts: ‘Design SW architecture’, ‘Write SW code’, ‘Test SW’ and ‘Write SW documentation’. This business process may be used, for example, by a software development company.

Further illustrated is a database of emotional states 3820 comprising: ‘Creative mood’, ‘Concentrated mood’ and ‘Systematic work mood’. The database may, for example, comprise an enumeration of the emotional states wherein each emotional state in the database is associated with an index. The database may further comprise parameters related to the emotional states, such as parameters of an environment control system that may be used to induce the emotional states. The different parts of the software creation business process are associated with emotional states in the database, the associations represented by the arrows in the illustration.

In one embodiment, a system may exist wherein a database of emotional states is not present. Instead the business process parts may, for example, be associated with values representing emotional states, without the use of a database.

Further illustrated in FIG. 38 is an emotion induction process 3830. The emotion induction process may comprise a function that receives parameters specifying an emotional state to be induced as input, and uses these parameters to induce the desired emotional state on users, for example, by changing the environment of the users. For this purpose the function may, for example, use a database which correlates emotional states with environmental control parameters. This database may be the illustrated database 3820. Alternatively, the emotion induction process input parameters may be environmental control parameters and the process may only change the users' environment.

An emotion induction function may regulate the emotion induction process by receiving input from an emotional state detector 3840. The emotional state detector may be a process that detects emotional states of users using any of the means previously described. The emotion induction function may use the emotional state detector to determine a current emotional state of users and accordingly determine a strategy for shifting the current emotional state of users to the desired emotional state.

The system illustrated in FIG. 38 may be operated, for example, on a software developer. The developer begins by performing the ‘design SW architecture’ business process part. Since this part is associated with the ‘creative mood’, the emotion induction process induces this mood on the developer. The emotional state detector monitors the developer's emotional state, allowing the emotion induction process to determine the best strategy for keeping the emotional state proximate to the desired emotional state.

As the developer advances to the next part of the business process, ‘Write SW code’, the desired emotional state changes. Now ‘Concentrated mood’ and ‘Systematic work mood’ are desired. This may be interpreted by the emotion induction process, for example, as an emotional state that is somewhere in between these two emotional states. The emotion induction process may attempt to keep the emotional state of the developer as proximate as possible to both of these emotional states. The emotion induction process may start inducing a desired emotional state some time prior to activation of the corresponding part of the business process. For example, the system may determine that the developer is about to finish the ‘write SW code’, identify the emotional state corresponding to the next part, ‘Test SW’, and start inducing that emotional state prior to the transition between the business process parts.

Another aspect of the embodiments of the methods for emotion-based normalization of user input is described herein. A variety of tasks that a user has to perform depend on subjective judgment. A user's subjective judgment may depend on a variety of factors among which is emotional state. As a result, the momentary emotional state may influence the subjective judgment.

The embodiments may adjust a plurality of user's inputs in order to be able to compare between the various inputs. Optionally, the adjustment may be based on the emotional states of the users.

In another example, when a user exhibits an emotional state which is beyond a predefined threshold, the effect of the user's emotional state on the user's input is compensated/counterbalanced by the method of the present invention.

Herein the term “entry field” may refer to a text-box, a widget (e.g. a radio button or a check-box), a drop-down menu, a button an entire electronic form, a combination thereof, or any other data receptacle capable of receiving input. The input may be received by using a mouse, a keyboard, a voice recognition device, a communication link, a combination thereof, any other device capable of generating input for the entry field, or without using a device at all.

Various methods may be used for adjusting user inputs according to the emotional state of the user so as to counterbalance an emotional bias of the user. In one embodiment, the following method may be used to adjust a user's input: The first step may be collecting the user's inputs while the user is experiencing different emotional states. The second step may be determining an unbiased input of the user. The unbiased input may be the average input of the user when the user is in an emotional state which is considered unbiased or in an emotional state within a predefined range. An average input may be, for example, a mathematical average of inputs, in the case where the input is numerical, or a typical selection of the user, in the case where the input is an action such as clicking a button. Alternatively, the unbiased input may be the average of all inputs from the user. The third step may be determining the average input when the user is in a specific emotional state, for example, when the user is very happy. The fourth step may be determining the effect of the specific emotional state on the user's input. For example, the effect may be determined by analyzing the difference between the unbiased input and the average input when the user is in the specific emotional state. After an effect is determined for the specific emotion it may be used to adjust a user's input. In one embodiment, the following steps may follow the previous steps. Alternatively, the following steps may follow a different method for determining the effect of a specific emotional state on user input: The fifth step may be receiving a user's input. The sixth step may be receiving a user's emotional state. The emotional state may be received from an emotion detection component, or be otherwise detected. In one embodiment, the emotional state of the user may be detected proximately to entering the input. The seventh step may be adjusting the input based on the effect of the emotional state of the user.

In one embodiment, another method, in which the input of more than one user is used, may be used to adjust at least one user's input. In this embodiment, the input of more than one user, input while the users are experiencing different emotional states, may be collected. Optionally, determining an unbiased input may be based on the inputs of more than one user. Optionally, determining the average input when a user is in a specific emotional state may be based on the inputs of more than one user. Optionally, the effect of a specific emotional state on user input may be based on the inputs of more than one user, and may be determined for more than one user. For example, the effect may be used to adjust the input of more than one user. In one embodiment, the effects of several emotional states on a user, or on more than one user, may be determined simultaneously.

there may be case where there is no need to adjust a user's input since the user's emotional state indicates that the input is not emotionally biased. In such a case, adjusting the user's input may comprise leaving the input as it is.

In one embodiment, adjusting user input may further be based on other contextual data pertaining to the user or the input.

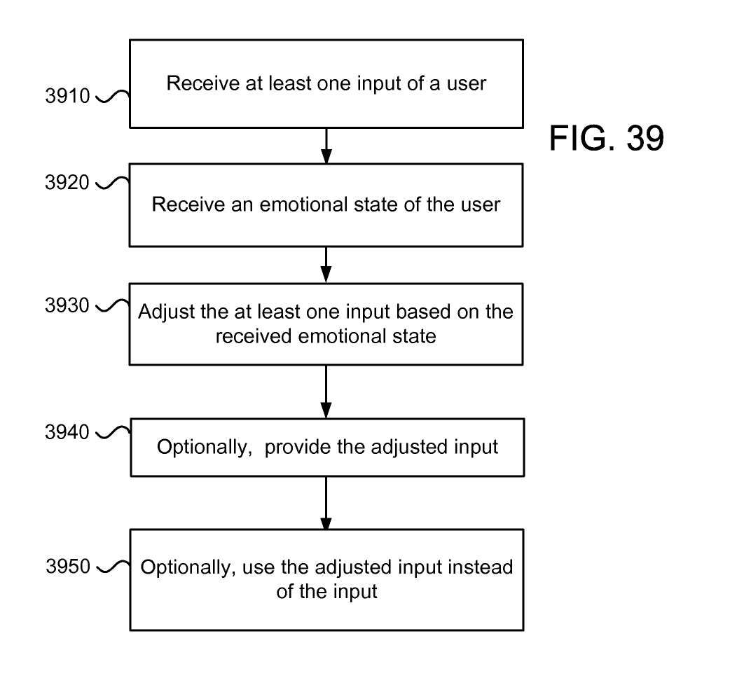

FIG. 39 is a flowchart illustrating the process steps of adjusting user input based on an emotional state of the user according to one embodiment. In step 3910 at least one input of a user is received. In step 3920 an emotional state of the user is received. In step 3930 the at least one input is adjusted based on the received emotional state.

Optionally, the step of receiving the emotional state of the user may comprise detecting the emotional state of the user.

In step 3940 the adjusted input may, optionally, be provided.

In step 3950 the adjusted input may, optionally, be used instead of the input.

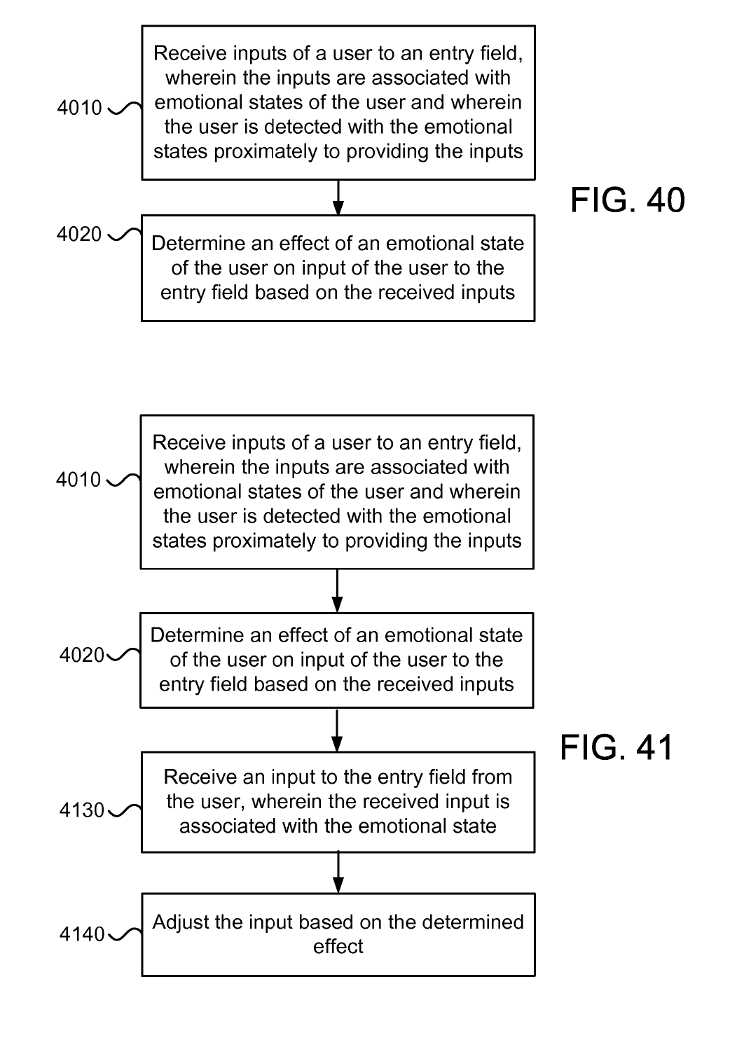

FIG. 40 is a flowchart illustrating the process steps of determining an effect of an emotional state of a user on input of the user to an entry field according to one embodiment. In step 4010 inputs of a user to an entry field are received. The inputs are associated with emotional states of the user, following detection of the emotional states in the user proximately to providing the inputs. In step 4020 an effect of an emotional state of the user on input of the user to the entry field is determined based on the received inputs.

FIG. 41 is a flowchart illustrating the process steps of adjusting user input to an entry field according to one embodiment. In step 4010 inputs of a user to an entry field are received. The inputs are associated with emotional states of the user, following detection of the emotional states in the user proximately to providing the inputs. In step 4020 an effect of an emotional state of the user on input of the user to the entry field is determined based on the received inputs. In step 4130 an input to the entry field from the user is received, wherein the received input is associated with the emotional state. In step 4140 the input is adjusted based on the determined effect.

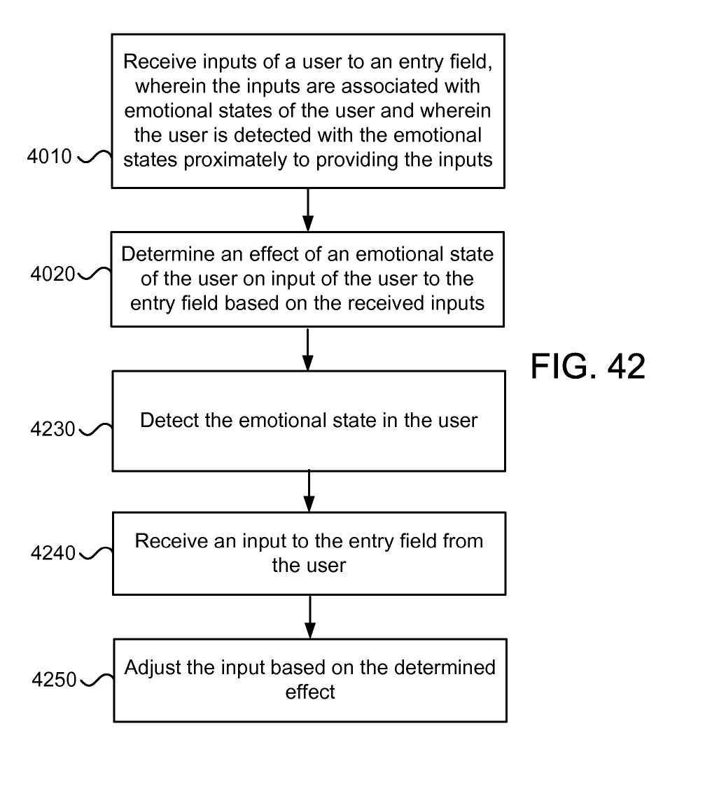

FIG. 42 is a flowchart illustrating the process steps of adjusting user input to an entry field according to one embodiment. In step 4010 inputs of a user to an entry field are received. The inputs are associated with emotional states of the user, following detection of the emotional states in the user proximately to providing the inputs. In step 4020 an effect of an emotional state of the user on input of the user to the entry field is determined based on the received inputs. In step 4230 the emotional state is detected in the user. In step 4240 an input to the entry field from the user is received. In step 4250 the input is adjusted based on the determined effect.

In one embodiment, the determined effect may be stored in a database.

In one embodiment, the determined effect may be stored in a user profile.

In one embodiment, the entry field may be part of a business process.

In one embodiment, unbiased input may be, for example, an average of inputs received from a user considered to be in an unbiased emotional state, an average of all inputs received from a user in all emotional states, or a desired average input used to standardize inputs received from all users.

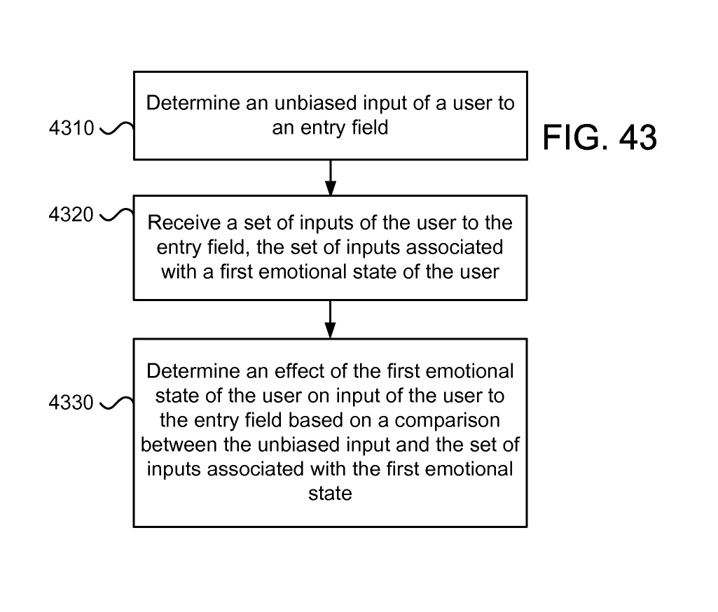

FIG. 43 is a flowchart illustrating the process steps of determining an effect of an emotional state of a user on input of the user to an entry field according to one embodiment. In step 4310 an unbiased input of a user to an entry field is determined. In step 4320 a set of inputs of the user to the entry field is received, the set of inputs associated with a first emotional state of the user. In step 4330 an effect of the first emotional state of the user on input of the user to the entry field is determined based on a comparison between the unbiased input and the set of inputs associated with the first emotional state.

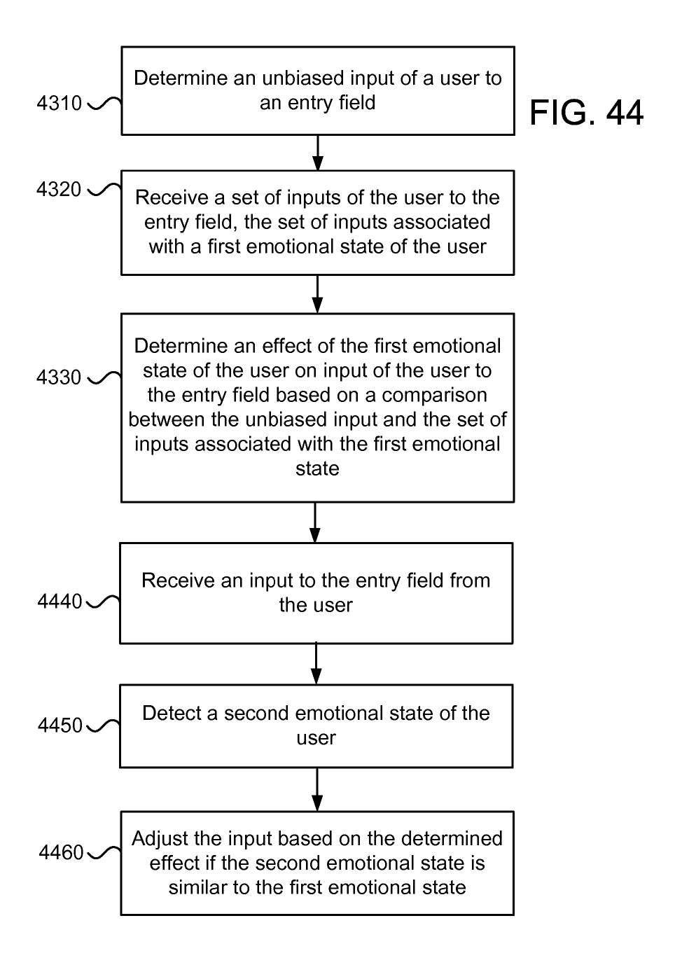

FIG. 44 is a flowchart illustrating the process steps of adjusting user input to an entry field according to one embodiment. In step 4310 an unbiased input of a user to an entry field is determined. In step 4320 a set of inputs of the user to the entry field is received, the set of inputs associated with a first emotional state of the user. In step 4330 an effect of the first emotional state of the user on input of the user to the entry field is determined based on a comparison between the unbiased input and the set of inputs associated with the first emotional state. In step 4440 an input to the entry field from the user is received. In step 4450 a second emotional state of the user is detected. In step 4460 the input is adjusted based on the determined effect if the second emotional state is similar to the first emotional state.

In one embodiment, the set of input values associated with the first emotional state of the user comprises input values input by the user proximately to detection of the first emotional state.

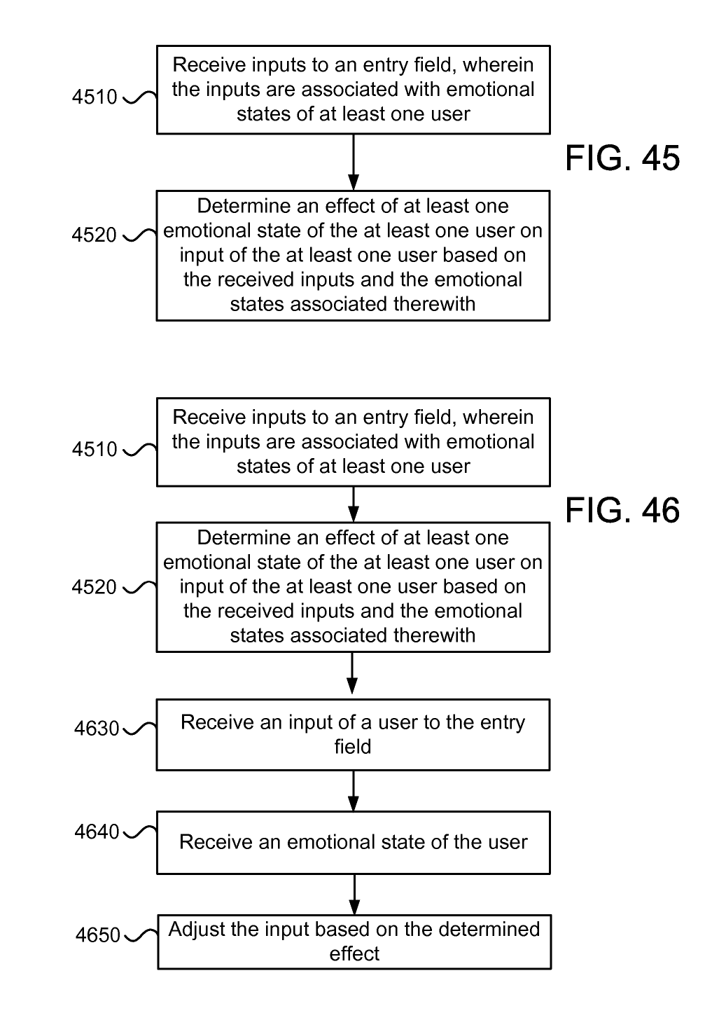

FIG. 45 is a flowchart illustrating the process steps of determining an effect of emotional states of users on input of the users to an entry field according to one embodiment. In step 4510 inputs to an entry field are received, wherein the inputs are associated with emotional states of at least one user. In step 4520, an effect of at least one emotional state of the at least one user on input of the at least one user is determined based on the received inputs and the emotional states associated therewith.

In one embodiment, emotional states of the at least one user are detected proximately to entering the inputs.

FIG. 46 is a flowchart illustrating the process steps of adjusting user input to an entry field according to one embodiment. In step 4510 inputs to an entry field are received, wherein the inputs are associated with emotional states of at least one user. In step 4520, an effect of at least one emotional state of the at least one user on input of the at least one user is determined based on the received inputs and the emotional states associated therewith. In step 4630 an input of a user to the entry field is received. In step 4640 an emotional state of the user is received. In step 4650 the input is adjusted based on the determined effect.

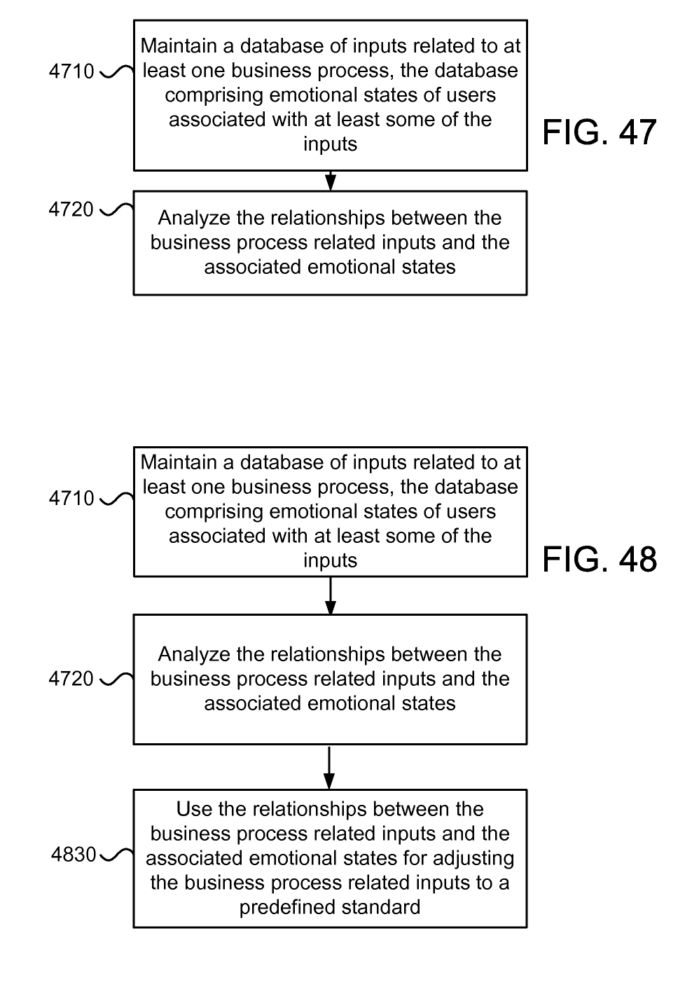

FIG. 47 is a flowchart illustrating the process steps of analyzing the relationships between business process related inputs and emotional states of users according to one embodiment. In step 4710 a database of inputs related to at least one business process is maintained, the database comprising emotional states of users associated with at least some of the inputs. In step 4720 the relationships between the business process related inputs and the associated emotional states are analyzed.

FIG. 48 is a flowchart illustrating the process steps of adjusting business process related inputs to a predefined standard according to one embodiment. In step 4710 a database of inputs related to at least one business process is maintained, the database comprising emotional states of users associated with at least some of the inputs. In step 4720 the relationships between the business process related inputs and the associated emotional states are analyzed. In step 4830 the relationships between the business process related inputs and the associated emotional states are used for adjusting the business process related inputs to a predefined standard.

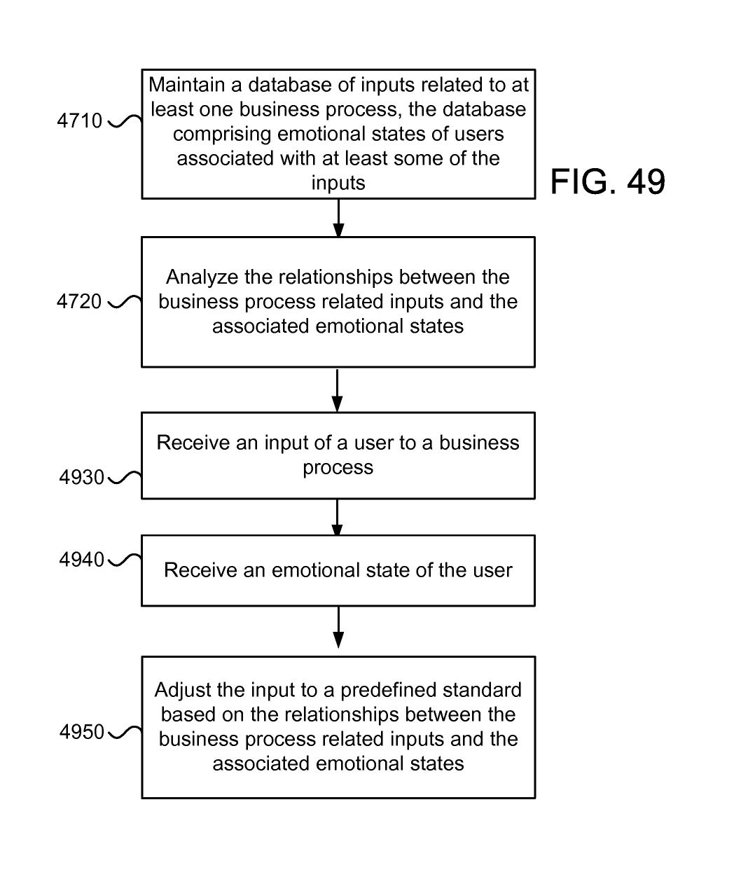

FIG. 49 is a flowchart illustrating the process steps of adjusting business process related inputs to a predefined standard according to one embodiment. In step 4710 a database of inputs related to at least one business process is maintained, the database comprising emotional states of users associated with at least some of the inputs. In step 4720 the relationships between the business process related inputs and the associated emotional states are analyzed. In step 4930 an input of a user to a business process is received. In step 4940 an emotional state of the user is received. In step 4950 the input is adjusted to a predefined standard based on the relationships between the business process related inputs and the associated emotional states.

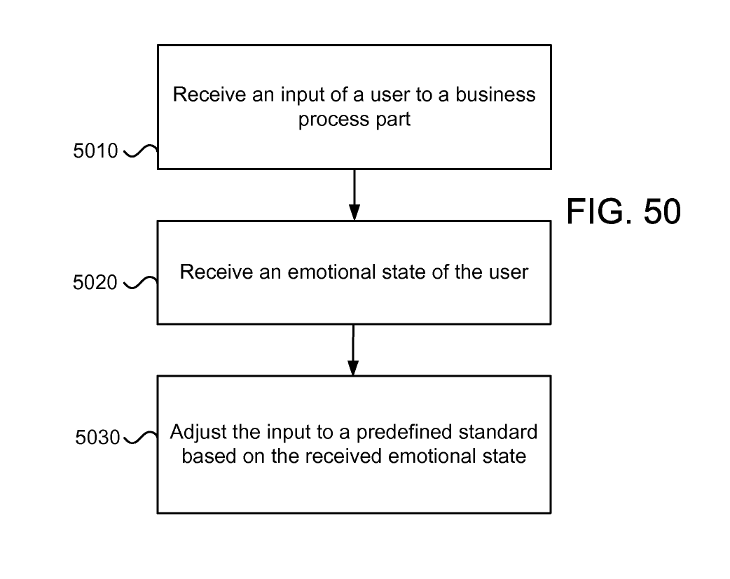

FIG. 50 is a flowchart illustrating the process steps of adjusting user input to a predefined standard based on an emotional state of the user according to one embodiment. In step 5010 an input of a user to a business process part is received. In step 5020 an emotional state of the user is received. In step 5030 the input is adjusted to a predefined standard based on the received emotional state.

In one embodiment, the step of receiving the emotional state of the user may comprise detecting the emotional state of the user.

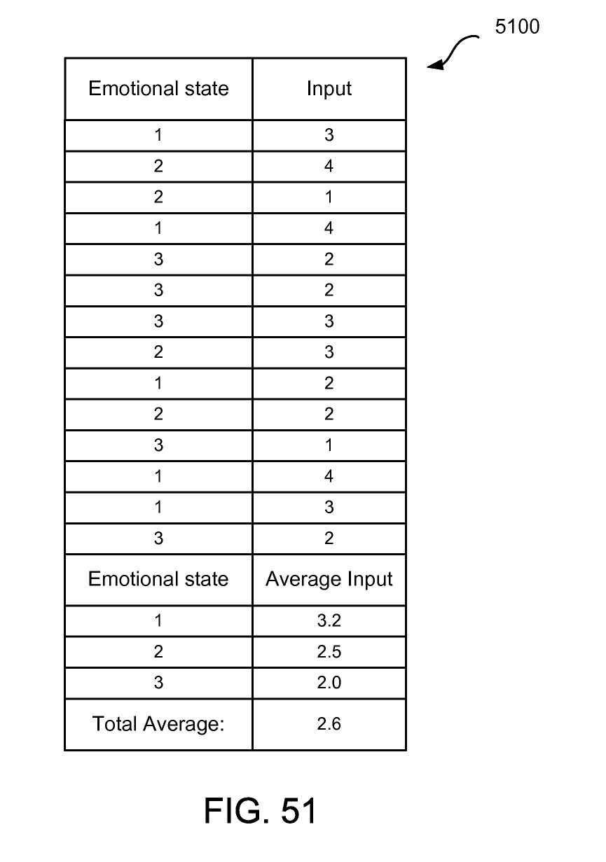

FIG. 51 is a schematic illustration of measurements and averages table 5100 according to one embodiment. In one embodiment, the illustrated table may be used to determine effects of emotional states on user input.

The upper part of the table illustrates data pertaining to a user's inputs to an entry field while the user is experiencing different emotional states. The illustrated table holds inputs of the user coupled with emotional states. In the illustrated example, the emotional states are labeled by integer values, and the inputs of the user are integer values ranging from 1 to 5. In one embodiment, the illustrated table may pertain to an entry field wherein a user is to evaluate a given item on a scale of 1 (low) to 5 (high), and the emotional state labeled ‘1’ may be a joyful mood of the user. Thus, according to this example, the first row of the table may indicate an instance wherein the user entered ‘3’ as input to the entry field while being in a joyful mood.

The lower part of the table illustrates data that is used to determine effects of emotional states on user input. The illustrated table holds average inputs of the user coupled with emotional states. Referring again to the previous example, the illustrated table may indicate that the average input of the user while being in a joyful mood is 3.2. This average is calculated from the user inputs illustrated in the upper part of the table.

In the bottom of the table, a total average of the user inputs is illustrated, which is the average of all the inputs illustrated in the upper part of the table. In this embodiment of the invention the total average may be considered an unbiased input of the user.

In one embodiment, the effect of a specific emotional state on the user's input may be determined by analyzing the difference between the unbiased input and the average input when the user is in the specific emotional state. Referring again to the previous example, the illustrated table may indicate that the difference between the unbiased input (2.6) and the average input when the user is in a joyful mood (3.2) is 0.6. Thus, it may be determined that when the user is in a joyful mood, he or she tends to overestimate when providing input. And thus, the next time the user enters input to the entry field, the input may be adjusted by subtracting 0.6 from it. The effects of emotional states ‘2’ and ‘3’ on the user's input may be determined similarly.

In one embodiment, the illustrated table may pertain to inputs and emotional states of more than one user.

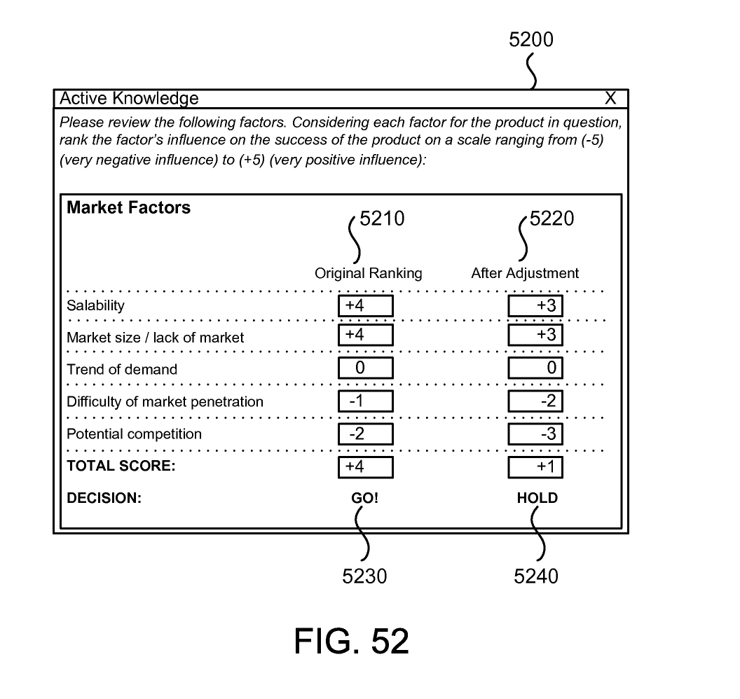

FIG. 52 is a schematic illustration of a screen display showing an informative window according to one embodiment. In the illustrated example, a user is asked to evaluate a set of given factors on a scale ranging from −5 to 5. The original rankings of the user 5210 are illustrated in the center column of the window. As illustrated, the original rankings were input by the user by selecting values from drop-down menus. The adjusted rankings of the user 5220 are illustrated in the right column of the window. These are the rankings after an effect of the emotional state of the user while entering the input on the input was taken into account. In the illustrated example, the user may have been in a joyful mood while entering the input, and thus the user's rankings were considered overly optimistic. In the illustrated example, the effect of the user's emotional state implied that the user's positive and negative rankings should be reduced.

Referring again to FIG. 52, as illustrated in the example, a decision based on a user's evaluations may change after the user's emotional state is taken into account. As illustrated, the original decision following the evaluation 5230 was ‘Go’ while the decision after adjustment 5240 is ‘Hold’. The informative window of FIG. 52 may be displayed to the user who performed the evaluation and entered the input or to another user such as the user's superior.

Without limiting the scope of the present invention, additional methods, that may be utilized by the disclosed embodiments, for detecting user emotion, include the following methods.

An emotional state of a user may be detected using a Man-Machine Interface (MMI). Any output produced by MMIs subsequently described may be used to for this task. Man-machine interfaces are a broad class of technologies that either present information to a human, for example, by displaying the information on a computer screen, or provide a machine with information about a human, for example, by analyzing a facial expression or analyzing the characteristics of a voice.

By integrating two or more MMIs in a single application, two different kinds of information that relate to a user's emotional state may be captured and the captured information analyzed together to produce a determination of the user's emotional state.

The MMIs include technologies capable of capturing the information. A wide variety of technologies may be used in various modes including (a) non-contact hardware such as auditory (e.g. voice analysis, speech recognition) or vision-based (e.g. facial expression analysis, gait analysis, head tracking, eye tracking, facial heat imaging), (b) non-contact software technologies such as artificial intelligence or content analysis software, (c) non-invasive contact hardware such as electromyograms or galvanic skin meters, (d) invasive hardware such as brain electrodes or blood tests, and (e) contact-based software that would, for example, analyze data from the contact-based hardware.

Various technologies may be used, either independently or in combination, to determine an emotional state of a user. For example, to determine an emotional state of a user, one camera aimed at the user may acquire images and video sequences of the user's head, face, eyes, and body. A second camera aimed at the user may obtain images and video sequences of the user's head, face, eyes, and body from a different angle. The two cameras may thus provide binocular vision capable of indicating motion and features in a third dimension, e.g., depth.

A third camera, which is sensitive to infrared wavelengths, may capture thermal images of the face of the user. A microphone may detect sounds associated with speech of the user. The three cameras and the microphone represent multiple MMIs that operate at the same time to acquire different classes of information about the user.

An additional MMI may be in the form of a digital display and stereo speakers that provide controllable information and stimulus to the user at the same time as the cameras and microphone are obtaining data. The information or stimulus may be images or sounds in the form of, for example, music or movies. The display and speakers may be controlled by a computer or a handheld device or by hard-wired control circuitry based on a measurement sequence that is either specified at the time of the measurement or specified at the time of the testing, by an operator or user.

The digital outputs of the three cameras in the form of sequences of video images may be communicated to image and video processing software. The software may process the images to produce information (content) about the position, orientation, motion, and state of the head, body, face, and eyes of the user. For example, the video processing software may include conventional routines that use the video data to track the position, motion, and orientation of the user's head (head tracking software), the user's body (gait analysis software), the user's face (facial expression analysis software), and the user's eyes (eye tracking software). The video processing software may also include conventional thermal image processing that determines thermal profiles and changes in thermal profiles of the user's face (facial heat imaging software).

The output of the speech recognition software may be delivered to a content analysis software. The content analysis software may include conventional routines that determine the content of the user's spoken words. The content analysis software may also get its feed directly from written text (e.g. user input), rather than a speech recognition software. In other words, the content analysis software may be capable of analyzing both the verbal speech and the written text of a user.

The facial response content provided from the facial expression analysis software (included in the image and video processing software) may be analyzed, for example, by determining the quantitative extent of facial muscle contraction (in other words, how far the muscle has contracted), which may be indicative of sadness. The software may also determine the location and movement of specific features of the face, including the lips, nose, or eyes, and translate those determinations into corresponding psychological states using pre-existing lookup tables.

Simultaneously, from the voice characteristics provided by the voice analysis software (included in the audio processing software), a psychology analysis software may determine a reduced quantitative audibility of the user's voice (the voice becomes softer) which may be indicative of sadness. A third analysis may determine, from the video data, a quantitative change in body posture that may also indicate sadness.

Simultaneously, from the characteristics of the thoughts and ideas expressed by the user (input directly into the computer as written text or translated into written text via the speech recognition software provided by the content analysis software), the psychology analysis software may determine an increased negativity in the user's linguistic expressions, which may again be indicative of sadness.

It may be determined that, when the user exhibits a certain degree of change in body posture, lowered voice audibility, muscle contraction, and negativity in speech content, the user is expressing sadness at a certain quantitative level, which may be expressed on a scale, such as a scale of 1 to 100 in which 100 is the saddest.

Each quantification of a characteristic or parameter may be associated with statistics such as standard deviation based on empirical data. Each quantification may be compared with statistical properties of general responses such as the degree of sadness that normal users typically display within a timeframe and may be evaluated with respect to a psychological range such as the one between minor and major depression. The range may also be an arbitrary numerical range, or a range of adjectives. Tables may be developed from previous data, and the comparison of the fresh data with that of the tables may help to map quantitative scales of a user's emotional state.

For example, a depression scale may range from 1 to 100, where 29 and below indicates normalcy, 30 thru 50 indicates minor depression, and 51 and above indicates major depression. The scale may help to assess the degree of the user's depression based on the response content.

The system may take advantage of various time scales with respect to the measurements, the measured properties, and the results. For example, the measurements may be taken over a period that could be seconds, hours, or days. For example, a user may be monitored for days at a time (e.g., by placing cameras and microphone recorders in the user's home and monitoring the user during free and private time spent at home in addition to time spent at the workplace). Long observations may be done in multiple sessions or continuously. The results may be based on measurements of varying time scales, or they may be based on the differences in the conclusions derived from shorter and longer measurements. For example, a user's mood may be measured for an hour at the same time each day, and mood patterns may then be derived from the variations in results from day to day.

Different time scales may also apply to the measured emotional state. Emotions are momentary affects that typically last a few seconds or minutes. Moods can last hours to days, and temperaments can last years to a lifetime. An emotional state may describe any of: emotions, moods, temperaments.

Measurements at one time scale may be used to arrive at conclusions regarding measured properties at a different time scale. For example, a user may be monitored for 30 minutes, and the properties of the responses the user displays may be recorded and analyzed. These properties may include the severity and frequency of the responses (e.g., an intense response indicating sadness, every two minutes), or a specific set of expressions that the user displays simultaneously or within a limited period of time. Based on these measurements, the system may indicate the user's moods and temperaments that last much longer than 30 minutes.

Each of the MMIs may have applications for which it is especially suitable and may be appropriate for measuring specific sets of parameters of a user. The parameters measured by different MMIs may be completely different or may be overlapping. The different MMI technologies may be used simultaneously to measure the user or may be used sequentially depending on the specific application. The MMI technologies can be loosely categorized as hardware-based or software-based. They can also be categorized with respect to their degree of intrusiveness as no-touch, touch but non-invasive, or touch and invasive.

No-touch hardware MMIs include, for example, auditory technologies, e.g., voice analysis, speech recognition, vision-based technologies, e.g., facial expression analysis (partial or full face), gait analysis (complete body or specific limbs), head tracking, eye tracking (iris, eyelids, pupil oscillations), infrared and heat imaging (e.g., of the face or another part of the body).

No-touch software-based technologies include, for example, artificial intelligence technologies, e.g., word selection analysis (spoken or written), and concept or content analysis.

Touch, but non-invasive, hardware-based technologies include, for example, technologies that measure muscle tension (electromyagram), sweat glands and skin conductance (galvanic skin meters), heart rhythm, breathing pattern, blood pressure, skin temperature, and brain encephalagraphy.

Invasive hardware-based technologies include, for example, electrodes placed in the brain and blood testing. Touch, software-based technologies include, for example, analysis software used with the touch hardware mentioned above.

Although the embodiments of the present invention have been described in considerable detail with reference to certain embodiments thereof, other embodiments are possible. Therefore, the spirit and scope of the appended claims should not be limited to the description of the embodiments contained herein.

It is appreciated that certain features of the embodiments, which are, for clarity, described in the context of separate embodiments, may also be provided in various combinations in a single embodiment. Conversely, various features of the embodiments, which are, for brevity, described in the context of a single embodiment, may also be provided separately or in any suitable sub-combination.

While the methods disclosed herein have been described and shown with reference to particular steps performed in a particular order, it will be understood that these steps may be combined, sub-divided, or reordered to form an equivalent method without departing from the teachings of the embodiments of the present invention. Accordingly, unless specifically indicated herein, the order and grouping of the steps is not a limitation of the embodiments of the present invention.

Any citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A computer-implemented method comprising: receiving indications of the emotional states of users interacting with at least one part of at least one business process; and identifying at least one problematic part of the at least one business process based on the received indication of the emotional states of the users.

2. The method of claim 1, further comprising the step of generating statistical data, which is relevant to at least one part of the business process, based on the received emotional states.

3. The method of claim 1, further comprising the step of generating a notification regarding the at least one problematic business process part.

4. The method of claim 1, further comprising the step of replacing, modifying or outsourcing the at least one problematic part.

5. The method of claim 1, wherein the at least one part of the at least one business process has an abstract representation, and the problematic part has an abstract representation having an abstract emotional status.

6. A computer-implemented method comprising: receiving emotional states of users of at least one part of at least one business process; generating statistical data based on the received emotional states; and providing data based on the generated statistical data in correlation with corresponding business process parts of the at least one business process.

7. The method of claim 6, wherein the step of generating the statistical data further comprises using contextual data relevant to the business process part.

8. The method of claim 6, wherein the statistical data comprises an estimation of an overall morale of the users in the business process part.

9. The method of claim 6, wherein the provided data comprises an indication of at least one problematic part of the at least one business process.

10. The method of claim 6, wherein the users belong to subgroups and the statistical data comprises at least one statistical value for at least one subgroup.

11. The method of claim 6, wherein at least one part of the at least one business process has an abstract representation of a business process.

12. The method of claim 11, wherein the provided data comprises at least one abstract emotional status correlated with at least one corresponding abstract representation of a business process part.

13. A computer-implemented method comprising: receiving emotional states of users of at least two interchangeable parts of a business process; generating statistical data based on the received emotional states; and comparing the at least two interchangeable parts based on the generated statistical data.

14. The method of claim 13, further comprising the step of setting at least one of the interchangeable parts as default based on the comparison.

15. The method of claim 13, wherein the two interchangeable parts are abstract representations of business process parts.

16. The method of claim 13, further comprising the step of supplying a user with one of the interchangeable parts and modifying an environment of the user based on his current emotional state.
